(19) United States
(12) Patent Application Publication
(10) Pub. No.: US 2024/0007147 A1
(43) Pub. Date: Jan. 4, 2024

(54) COMMUNICATING RECONFIGURABLE INTELLIGENT SURFACE (RIS) INFORMATION TO SUPPORT RIS-DIVISION MULTIPLE ACCESS

(71) Applicant: QUALCOMM INCORPORATED, San Diego, CA (US)

(72) Inventors: Saeid Sahraei, San Diego, CA (US); Renqiu Wang, San Diego, CA (US); Yu Zhang, San Diego, CA (US); Hung Dinh Ly, San Diego, CA (US); Krishna Kiran Mukkavilli, San Diego, CA (US)

(21) Appl. No.: 18/253,008

(22) PCT Filed: Jan. 14, 2021
(86) PCT No.: PCT/CN2021/071669

§ 371 Date: May 15, 2023

(51) Int. Cl. H04B 7/04; H04B 7/26; H04B 7/08; H04B 7/06

(52) U.S. Cl. CPC H04B 7/04013; H04B 7/2612; H04B 7/088; H04B 7/06966

(57) ABSTRACT

Methods, systems, and devices for wireless communications are described. In some systems, abase station may employ a reconfigurable intelligent surface (RIS) that uses passive components to reflect incoming signals in one or more directions. The base station may dynamically configure the RIS to reflect an incoming signal in a specific direction. The base station may transmit, to one or more user equipments (UEs), a message indicating a configuration of one or more RISs. In some aspects, the configuration may include a location of a RIS, reflection angles of a RIS, or both. Based on the configuration, a UE may select a RIS to facilitate communications with the base station. The base station and the UE may communicate via the selected RIS. In some examples, the base station may communicate with one or more UEs via one or more RISs using RIS division multiple access (RDMA).

### CROSS REFERENCE

The present Application is a 371 national stage filing of International PCT Application No. PCT/CN2021/071669 by Sahraei et al. entitled “COMMUNICATING RECONFIGURABLE INTELLIGENT SURFACE (RIS) INFORMATION TO SUPPORT RIS-DIVISION MULTIPLE ACCESS,” filed Jan. 14, 2021, which is assigned to the assignee hereof, and which is expressly incorporated by reference in its entirety herein.

### FIELD OF TECHNOLOGY

The following relates to wireless communications, including communicating reconfigurable intelligent surface (RIS) information to support RIS-division multiple access (RDMA).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a base station may communicate with a UE using an active antenna unit (AAU). In some cases, the AAU may amplify and retransmit incoming signals between the base station and the UE. However, the AAU may be associated with a relatively high power consumption (e.g., above a power consumption threshold) based on performing power amplification to retransmit the signals. In some systems, such power consumption and resource overhead for retransmission by an AAU may be undesirable and inefficient.

### SUMMARY

The described techniques relate to improved methods, systems, devices, and apparatuses that support communicating reconfigurable intelligent surface (RIS) information to support RIS-division multiple access (RDMA). Generally, the described techniques provide for a base station to communicate RIS configuration information with one or more user equipments (UEs) in a wireless communications system. The base station may determine a configuration of a RIS and may transmit, to a UE, an indication of the configuration. In some examples, the indication may include a location of the RIS, an uplink reflection angle of the RIS, a downlink reflection angle of the RIS, or a combination thereof. In some examples, the indication may include a set of time and frequency resources associated with the RIS. Based on the indicated configuration, the UE may select the RIS to facilitate beamforming communications with the base station. Using the selected RIS, the UE may communicate with the base station via the RIS. For example, the base station may transmit a beamformed communication in a direction of the RIS and the RIS may reflect (e.g., deflect, refract) the beamformed communication in a direction of the UE based on a downlink reflection angle of the RIS. In some examples, the base station may communicate with one or more UEs via one or more RISs, one or more sub-RISs, or a combination thereof using RDMA techniques.

A method for wireless communications at a UE is described. The method may include receiving, from a base station, a message indicating a configuration of a RIS, selecting the RIS to facilitate communications with the base station based on the configuration of the RIS, and communicating with the base station via the RIS based on the selecting.

An apparatus for wireless communications at a UE is described. The apparatus may include a processor, memory in electronic communication with the processor, and instructions stored in the memory. The instructions may be executable by the processor to receive, from a base station, a message indicating a configuration of a RIS, select the RIS to facilitate communications with the base station based on the configuration of the RIS, and communicate with the base station via the RIS based on the selecting.

Another apparatus for wireless communications at a UE is described. The apparatus may include means for receiving, from a base station, a message indicating a configuration of a RIS, means for selecting the RIS to facilitate communications with the base station based on the configuration of the RIS, and means for communicating with the base station via the RIS based on the selecting.

A non-transitory computer-readable medium storing code for wireless communications at a UE is described. The code may include instructions executable by a processor to receive, from a base station, a message indicating a configuration of a RIS, select the RIS to facilitate communications with the base station based on the configuration of the RIS, and communicate with the base station via the RIS based on the selecting.

In some examples of the method, apparatuses, and non-transitory computer-readable medium described herein, communicating with the base station via the RIS may include operations, features, means, or instructions for performing a beamforming operation in a direction corresponding to the RIS, selecting a communication beam based on the beamforming operation, and communicating with the base station via the RIS using the selected communication beam.

In some examples of the method, apparatuses, and non-transitory computer-readable medium described herein, the RIS includes a set of multiple elements and the method, apparatuses, and non-transitory computer-readable medium may include further operations, features, means, or instructions for determining a subset of elements of the set of multiple elements of the RIS based on the configuration of the RIS, where the communicating includes communicating with the base station via the subset of elements.

In some examples of the method, apparatuses, and non-transitory computer-readable medium described herein, the RIS includes a set of multiple elements and the method, apparatuses, and non-transitory computer-readable medium may include further operations, features, means, or instructions for accessing a wireless network including the base station, where the message may be received based on accessing the wireless network and the message assigns the UE a subset of elements of the set of multiple elements of the RIS for communication.

In some examples of the method, apparatuses, and non-transitory computer-readable medium described herein, the message indicates a set of multiple configurations for a set of multiple RISs in a wireless network.

In some examples of the method, apparatuses, and non-transitory computer-readable medium described herein, selecting the RIS may include operations, features, means, or instructions for selecting the RIS of the set of multiple RISs for communication based on a position of the UE, a position of the base station, a position of the RIS indicated by the configuration of the RIS, an uplink reflection angle of the RIS indicated by the configuration of the RIS, a downlink reflection angle of the RIS indicated by the configuration of the RIS, a reference signal measurement associated with the RIS, or a combination thereof.

Some examples of the method, apparatuses, and non-transitory computer-readable medium described herein may further include operations, features, means, or instructions for transmitting, to the base station, a feedback message indicating the selected RIS.

In some examples of the method, apparatuses, and non-transitory computer-readable medium described herein, the feedback message includes a channel state information (CSI) feedback message.

In some examples of the method, apparatuses, and non-transitory computer-readable medium described herein, the message assigns the RIS to the UE for a set of time resources, a set of frequency resources, or both and the communicating includes communicating with the base station via the assigned RIS in the set of time resources, the set of frequency resources, or both.

In some examples of the method, apparatuses, and non-transitory computer-readable medium described herein, the configuration of the RIS indicates a set of time resources, a set of frequency resources, or both assigned to the RIS.

In some examples of the method, apparatuses, and non-transitory computer-readable medium described herein, the configuration of the RIS includes a location of the RIS, an uplink reflection angle of the RIS, a downlink reflection angle of the RIS, or a combination thereof.

In some examples of the method, apparatuses, and non-transitory computer-readable medium described herein, the RIS includes a first sub-RIS of a total RIS and the location of the RIS includes a relative location of the first sub-RIS relative to a second sub-RIS of the total RIS, the uplink reflection angle of the RIS includes a relative uplink reflection angle of the first sub-RIS relative to an uplink reflection angle of the second sub-RIS of the total RIS, the downlink reflection angle of the RIS includes a relative downlink reflection angle of the first sub-RIS relative to a downlink reflection angle of the second sub-RIS of the total RIS, or a combination thereof.

In some examples of the method, apparatuses, and non-transitory computer-readable medium described herein, the message includes a downlink control information (DCI) message, a radio resource control (RRC) configuration message, a medium access control (MAC) control element (CE), or a combination thereof.

A method for wireless communications at a base station is described. The method may include determining a configuration of a RIS, transmitting, to a UE, a message indicating the configuration of the RIS, and communicating with the UE via the RIS based on the configuration of the RIS.

An apparatus for wireless communications at a base station is described. The apparatus may include a processor, memory in electronic communication with the processor, and instructions stored in the memory. The instructions may be executable by the processor to determine a configuration of a RIS, transmit, to a UE, a message indicating the configuration of the RIS, and communicate with the UE via the RIS based on the configuration of the RIS.

Another apparatus for wireless communications at a base station is described. The apparatus may include means for determining a configuration of a RIS, means for transmitting, to a UE, a message indicating the configuration of the RIS, and means for communicating with the UE via the RIS based on the configuration of the RIS.

A non-transitory computer-readable medium storing code for wireless communications at a base station is described. The code may include instructions executable by a processor to determine a configuration of a RIS, transmit, to a UE, a message indicating the configuration of the RIS, and communicate with the UE via the RIS based on the configuration of the RIS.

In some examples of the method, apparatuses, and non-transitory computer-readable medium described herein, communicating with the UE via the RIS may include operations, features, means, or instructions for performing a beamforming operation in a direction corresponding to the RIS, selecting a communication beam based on the beamforming operation, and communicating with the UE via the RIS using the selected communication beam.

In some examples of the method, apparatuses, and non-transitory computer-readable medium described herein, the message indicates a set of multiple configurations for a set of multiple RISs in a wireless network including the base station.

Some examples of the method, apparatuses, and non-transitory computer-readable medium described herein may further include operations, features, means, or instructions for receiving, from the UE, a feedback message indicating that the UE selected the RIS for communication, where communicating with the UE via the RIS may be based on the feedback message.

In some examples of the method, apparatuses, and non-transitory computer-readable medium described herein, the feedback message includes a CSI feedback message.

In some examples of the method, apparatuses, and non-transitory computer-readable medium described herein, the message assigns the RIS to the UE for a set of time resources, a set of frequency resources, or both and the communicating includes communicating with the UE via the assigned RIS in the set of time resources, the set of frequency resources, or both.

In some examples of the method, apparatuses, and non-transitory computer-readable medium described herein, determining the configuration of the RIS may include operations, features, means, or instructions for configuring an uplink reflection angle of the RIS, a downlink reflection angle of the RIS, or both, where the configuration of the RIS includes the uplink reflection angle of the RIS, the downlink reflection angle of the RIS, or both.

In some examples of the method, apparatuses, and non-transitory computer-readable medium described herein, configuring the uplink reflection angle of the RIS, the downlink reflection angle of the RIS, or both may include operations, features, means, or instructions for transmitting a configuration message to the RIS, the configuration message indicating respective uplink reflection angles, respective downlink reflection angles, or both for a set of multiple elements of the RIS.

In some examples of the method, apparatuses, and non-transitory computer-readable medium described herein, the UE includes a first UE and the RIS includes a first RIS and the method, apparatuses, and non-transitory computer-readable medium may include further operations, features, means, or instructions for communicating with a second UE via a second RIS.

In some examples of the method, apparatuses, and non-transitory computer-readable medium described herein, the UE includes a first UE, the RIS includes a set of multiple elements, and the communicating includes communicating with the first UE via a first subset of elements of the set of multiple elements of the RIS. Some examples of the method, apparatuses, and non-transitory computer-readable medium described herein may further include operations, features, means, or instructions for communicating with a second UE via a second subset of elements of the set of multiple elements of the RIS.

Some examples of the method, apparatuses, and non-transitory computer-readable medium described herein may further include operations, features, means, or instructions for determining that the first UE leaves a wireless network including the base station, determining that a third UE accesses the wireless network including the base station, and reassigning the first subset of elements of the set of multiple elements of the RIS to the third UE based on the third UE accessing the wireless network and the first UE leaving the wireless network.

Some examples of the method, apparatuses, and non-transitory computer-readable medium described herein may further include operations, features, means, or instructions for activating the RIS based on the configuration of the RIS, where communicating with the UE via the RIS may be based on the activating.

In some examples of the method, apparatuses, and non-transitory computer-readable medium described herein, the configuration of the RIS indicates a set of time resources, a set of frequency resources, or both assigned to the RIS.

In some examples of the method, apparatuses, and non-transitory computer-readable medium described herein, the configuration of the RIS includes a location of the RIS, an uplink reflection angle of the RIS, a downlink reflection angle of the RIS, or a combination thereof.

In some examples of the method, apparatuses, and non-transitory computer-readable medium described herein, the RIS includes a first sub-RIS of a total RIS and the location of the RIS includes a relative location of the first sub-RIS relative to a second sub-RIS of the total RIS, the uplink reflection angle of the RIS includes a relative uplink reflection angle of the first sub-RIS relative to an uplink reflection angle of the second sub-RIS of the total RIS, the downlink reflection angle of the RIS includes a relative downlink reflection angle of the first sub-RIS relative to a downlink reflection angle of the second sub-RIS of the total RIS, or a combination thereof.

In some examples of the method, apparatuses, and non-transitory computer-readable medium described herein, the message includes a DCI message, an RRC configuration message, a MAC CE, or a combination thereof.

### BRIEF DESCRIPTION OF THE DRAWINGS

FIGS. 1 through 5 illustrate examples of wireless communications systems that support communicating reconfigurable intelligent surface (RIS) information to support RIS-division multiple access (RDMA) in accordance with aspects of the present disclosure.

FIG. 6 illustrates an example of a process flow that supports communicating RIS information to support RDMA in accordance with aspects of the present disclosure.

FIGS. 7 and 8 show block diagrams of devices that support communicating RIS information to support RDMA in accordance with aspects of the present disclosure.

FIG. 9 shows a block diagram of a communications manager that supports communicating RIS information to support RDMA in accordance with aspects of the present disclosure.

FIG. 10 shows a diagram of a system including a device that supports communicating RIS information to support RDMA in accordance with aspects of the present disclosure.

FIGS. 11 and 12 show block diagrams of devices that support communicating RIS information to support RDMA in accordance with aspects of the present disclosure.

FIG. 13 shows a block diagram of a communications manager that supports communicating RIS information to support RDMA in accordance with aspects of the present disclosure.

FIG. 14 shows a diagram of a system including a device that supports communicating RIS information to support RDMA in accordance with aspects of the present disclosure.

FIGS. 15 through 18 show flowcharts illustrating methods that support communicating RIS information to support RDMA in accordance with aspects of the present disclosure.

### DETAILED DESCRIPTION

In some wireless communications systems (e.g., systems implementing a massive multiple input-multiple output (MIMO) communication scheme), wireless devices may implement spatial division multiple access (SDMA) to increase signaling throughput. For example, a base station may use beamforming techniques to communicate with multiple user equipments (UEs) concurrently by using spatial dimensions provided by an environment. However, in some cases, physical proximity or environmental factors (e.g., interference, blockage) may impair beamforming communications between the base station and the multiple UEs. In some cases, to overcome such impairments, the base station may employ an active antenna unit (AAU) to act as a relay between the base station and the multiple UEs. The AAU may include one or more antenna ports, radio frequency (RF) chains, and power amplifiers. The AAU may allow the base station to increase spatial diversity, beamforming gain, and cell coverage. For example, the AAU may receive a beamformed communication from the base station, amplify the beamformed communication, and re-transmit the beamformed communication to a UE. As such, in comparison to receiving the beamformed communication directly from the base station, the UE may have a higher likelihood of successfully receiving the beamformed communication via the AAU. However, active components (e.g., RF chains, power amplifiers) used by the AAU to amplify signals may be associated with increased power consumption. For example, a power amplifier at the AAU may utilize a significant power overhead to amplify and re-transmit a received signal. Such power overhead may be undesirable and inefficient in some systems.

In some examples, the base station may employ a reconfigurable intelligent surface (RIS) that uses passive components (e.g., capacitors, resistors) to reflect incoming signals in one or more directions without utilizing a significant power overhead. For example, the RIS may use a capacitor and a resistor to reflect a signal in a specific direction (e.g., instead of using a power amplifier to amplify and re-transmit the signal). As such, the RIS may increase cell coverage, spatial diversity, and beamforming gain while consuming less power than an AAU. In some aspects, the base station may dynamically configure the RIS to reflect an incoming signal in a specific direction. For example, the base station may configure the RIS to reflect a beamformed communication in a direction of a UE based on a location of the UE. Similarly, the UE may transmit a beamformed communication in a direction of the RIS based on a base station configuration or a UE selection. To effectively implement the RIS, the base station may indicate configuration information for the RIS to the UE. The configuration information may include a location of the RIS, an uplink reflection angle of the RIS, a downlink reflection angle of the RIS, or a combination thereof. In some examples, the base station may transmit, to the UE (e.g., via a RIS), configuration information for multiple RISs in a coverage area of the base station. The UE may select one of the multiple RISs to facilitate communication with the base station based on the configuration information for the multiple RISs. In some aspects, the UE may transmit, to the base station, feedback indicating the selected RIS.

The base station may communicate with multiple UEs via one or more RISs using RIS-division multiple access (RDMA). For example, the base station may subdivide a RIS into multiple subsets of elements and use different subsets of elements to communicate with different UEs. Additionally or alternatively, the base station may use multiple RISs distributed throughout the coverage area to communicate with the multiple UEs. In some examples, the base station may use multiple RISs to communicate with a single UE. For example, if a path between a UE and the base station using a first RIS is obstructed, experiences interference, or otherwise drops below a quality or signal strength threshold, the base station may use a second RIS to communicate with the UE via a different path. As such, RDMA may provide increased spatial diversity, cell coverage, and throughput, among other benefits. To effectively implement RDMA, the base station may transmit configuration information for one or more RISs to each of the multiple UEs. In some aspects, the configuration information may identify a specific RIS and a set of time and frequency resources associated with the specific RIS. For example, the base station may indicate, to a UE of the multiple UEs, an identifier of a RIS, a configuration of the RIS, and a resource allocation associated with the RIS. As such, the base station may allocate, to a UE, RIS resources in addition to time and frequency resources in a resource allocation for communications. The base station may utilize the one or more RISs in RDMA to facilitate communications between the base station and one or more UEs in a wireless communications system.

Aspects of the disclosure are initially described in the context of wireless communications systems. Aspects of the disclosure are further illustrated by and described with reference to process flows, apparatus diagrams, system diagrams, and flowcharts that relate to communicating RIS information to support RDMA.

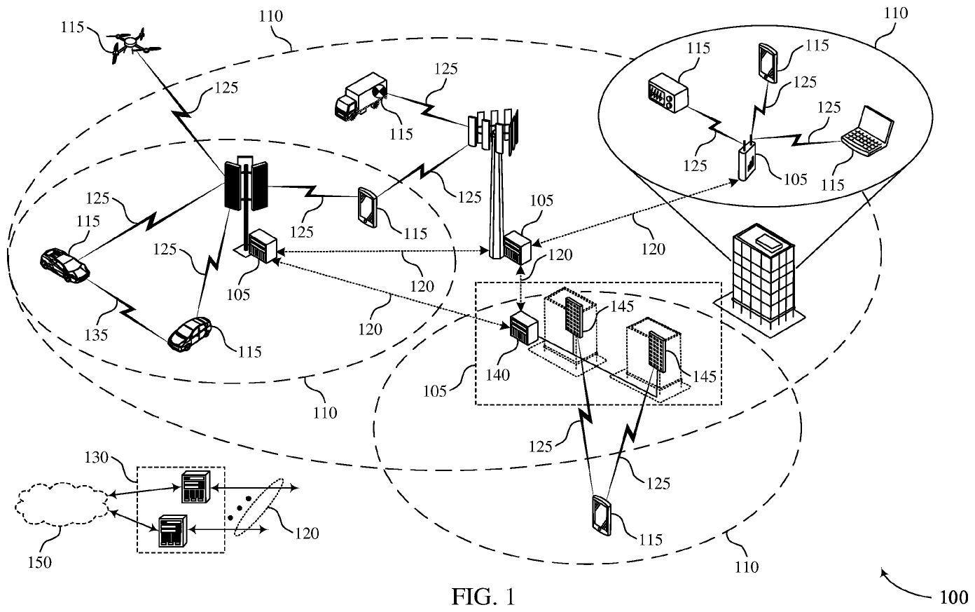

FIG. 1 illustrates an example of a wireless communications system 100 that supports communicating RIS information to support RDMA in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or a combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or a combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some cases, wireless devices in a wireless communications system 100 (e.g., a system implementing a massive MIMO communication scheme) may utilize SDMA to increase signaling throughput. For example, a base station 105 may use beamforming techniques to communicate with multiple UEs 115 concurrently by using spatial dimensions provided by an environment. However, in some cases, environmental factors (e.g., interference or blockage) may degrade performance of beamforming communications. For example, if a path between a UE 115 and the base station 105 is obstructed, communications between the UE 115 and the base station 105 may drop below a quality or signal strength threshold. Random reflections and low beamforming gain may further reduce the reliability of the beamformed communications.

In some cases, the base station 105 may employ an AAU to facilitate beamforming communications between the base station 105 and the multiple UEs 115. The AAU may include one or more power amplifiers and antenna ports, and each of the antenna ports may be associated with an RF chain. The AAU may receive a beamformed communication from the base station 105, amplify the beamformed communication, and re-transmit the amplified beamformed communication to a UE 115. Similarly, the AAU may receive a beamformed communication from the UE 115 and re-transmit the communication to the base station 105. As such, if a first path between a UE 115 and the base station 105 is obstructed, the UE 115 may use the AAU to communicate with the base station 105 via a second path. Thus, the AAU may allow the base station 105 to increase spatial diversity, beamforming gain, and cell coverage. However, active components (e.g., power amplifiers, RF chains) employed by the AAU may be associated with increased power consumption. For example, a power amplifier employed by the AAU may use a significant power overhead to amplify and re-transmit a signal from the base station 105 to the UE 115.

In some examples, the base station 105 may additionally or alternatively employ a RIS that uses passive components (e.g., capacitors, resistors) to reflect signals in one or more directions without utilizing a significant power overhead. Employing the RIS may increase spatial diversity, throughput, beamforming gain, and cell coverage while consuming less power than an AAU. Specifically, the RIS may extend network coverage using a relatively low (e.g., negligible) amount of power. Further, the RIS may have a predictable behavior and may be used by a wireless device (e.g., a base station 105, a UE 115) to perform beamforming operations. For example, the wireless device may perform a beamforming operation (e.g., a beam measurement procedure) in a direction corresponding to the RIS and may select a communication beam corresponding to the direction of the RIS based on the beamforming operation.

In some examples the base station 105 may dynamically configure the RIS to reflect a signal (e.g., an impinging wave) in a specific direction. To effectively implement the RIS, the base station 105 may indicate configuration information for the RIS to the UE 115. The configuration information may include a location of the RIS, an uplink reflection angle of the RIS, a downlink reflection angle of the RIS, or a combination thereof. In some examples, the base station 105 may implement RDMA by using one or more RISs, one or more sub-RISs, or a combination thereof to communicate with one or more UEs 115 within the coverage area 110. In such examples, the base station 105 may transmit configuration information for the one or more RISs, the one or more sub-RISs, or the combination thereof to the one or more UEs 115. The configuration information may include locations of the RISs, uplink reflection angles of the RISs, downlink reflection angles of the RISs, or a combination thereof. In some examples, the locations, uplink reflection angles, and downlink reflection angles may be relative (e.g., relative to another RIS) or explicit. The configuration information may include a single reflection angle for a RIS (e.g., if behavior of the RIS is reciprocal for uplink and downlink) or multiple reflection angles for a RIS (e.g., if behavior of the RIS is not reciprocal for uplink and downlink). Additionally or alternatively, the configuration information may include a set of time and frequency resources associated with a RIS. That is, the base station 105 may allocate a set of time and frequency resources associated with a RIS to the one or more UEs 115. Using one or more of the techniques described herein, RDMA may enable a passive MIMO communication scheme between a base station 105 and one or more UEs 115. That is, the base station 105 may multiplex the one or more UEs 115 with spatially separated RISs that employ passive components.

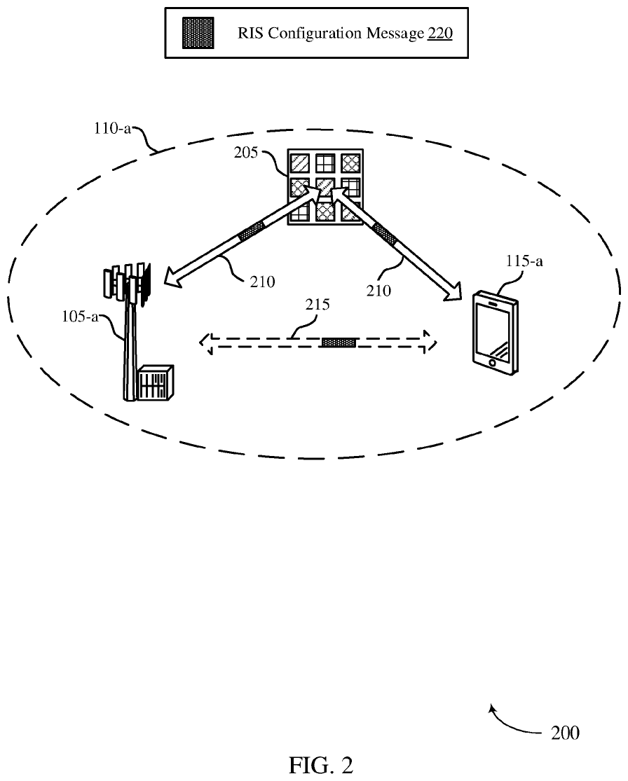

FIG. 2 illustrates an example of a wireless communications system 200 that supports communicating RIS information to support RDMA in accordance with aspects of the present disclosure. The wireless communications system 200 may implement aspects of the wireless communications system 100. For example, the wireless communications system 200 may include a UE 115-a and a base station 105-a, which may be examples of corresponding devices described herein with reference to FIG. 1. In some aspects, the UE 115-a and the base station 105-a may communicate within a geographic coverage area 110-a of the base station 105-a and may use a RIS 205 to communicate via a communication link 210. The base station 105-a may transmit, to the UE 115-a via the communication link 210 or a direct communication link 215, a RIS configuration message 220 that indicates configuration information for a RIS 205. The RIS configuration message 220 may support the UE 115-a selecting a RIS 205 based on the indicated configuration information and communicating with the base station 105-a via the selected RIS 205. Utilizing the selected RIS 205 may, in turn, allow the UE 115-a and the base station 105-a to communicate with increased spatial diversity, beamforming gain, and reliability.

In some systems, a base station 105-a may determine a configuration of a RIS 205. Based on the determined configuration of the RIS 205, the base station 105-a may generate a RIS configuration message 220. In some examples, the base station 105-a may transmit the RIS configuration message 220 to the UE 115-a via the RIS 205 using the communication link 210. In some other examples, the base station 105-a may transmit the RIS configuration message 220 directly to the UE 115-a over the direct communication link 215. Based on the RIS configuration information, the UE 115-a may select the RIS 205 to facilitate communications with the base station 105-a. Based on selecting the RIS 205, the UE 115-a may communicate with the base station 105-a via the RIS 205.

The RIS 205 may be a near passive device that reflects incoming signals in a specific direction according to a configuration of the RIS 205. In some examples, the configuration of the RIS 205 may be preconfigured, statically or semi-statically configured, or configured by a network (e.g., configured by the base station 105-a). For example, the base station 105-a may transmit a message to the RIS 205 configuring one or more elements of the RIS. The RIS 205 may include a processing component (e.g., a processor) that may determine a configuration for the RIS 205 (e.g., based on a message from the base station 105-a) and may adjust one or more parameters of the RIS 205 to support the configuration. For example, the RIS 205 may use one or more capacitors, resistors, and other passive components to reflect signals between the base station 105-a and the UE 115-a (e.g., rather than using active components to amplify and re-transmit the signals). The RIS 205 may adjust the capacitors, resistors, or combination thereof to support a specific configuration for one or more elements of the RIS 205 (e.g., based on a configuration message from the base station 105-a). The RIS 205 may have a wired connection or a wireless connection with the base station 105-a and may be located anywhere in the coverage area 110-a of the base station 105-a.

In some cases, the configuration information of the RIS configuration message 220 may indicate a location of the RIS 205, an uplink reflection angle of the RIS 205, a downlink reflection angle of the RIS 205, or a combination thereof. In some examples, the base station 105-a may indicate the location, the uplink reflection angle, the downlink reflection angle, or a combination thereof as relative or explicit values. Additionally or alternatively, the RIS configuration message 220 may indicate a set of time and frequency resources associated with the RIS 205. For example, the base station 105-a may allocate a frequency and a time slot to the UE 115-a for a beamformed communication based on a configuration of the RIS 205.

In some examples, the base station 105-a may determine the configuration of the RIS 205 based on a location of the UE 115-a. For example, the base station may adjust a reflection angle (e.g., an uplink reflection angle) of the RIS 205 based on the location of the UE 115-a so that a signal transmitted from the UE 115-a is properly deflected to the base station 105-a. In some examples, the base station 105-a may adjust a configuration of the RIS 205 periodically. For example, the RIS 205 may support different uplink reflection angles, downlink reflection angles, or both in different symbols, sub-slots, slots, subframes, frames, or some combination thereof.

In some cases, the UE 115-a may transmit, to the base station 105-a, a feedback message in response to the RIS configuration message 220. The feedback message may indicate a selection of the RIS 205. The UE 115-a may select the RIS 205 to facilitate communications with the base station 105-a based on a location of the UE 115-a, a location of the base station 105-a, a location of the RIS 205 indicated by the RIS configuration message 220, an uplink reflection angle of the RIS 205 indicated by the RIS configuration message 220, a downlink reflection angle of the RIS 205 indicated by the RIS configuration message 220, a signal measurement (e.g., reference signal received power (RSRP), reference signal received quality (RSRQ), received signal strength indicator (RSSI), signal-to-noise ratio (SNR), signal-to-noise plus interference ratio (SNIR), signal-to-interference plus noise ratio (SINR)) associated with the direct communication link 215, the communication link 210 via the RIS 205, or both, or a combination thereof. In some examples, the UE 115-a may transmit the feedback message via the RIS 205 using the communication link 210. For example, the UE 115-a may transmit the feedback message in a direction of the RIS 205 and the RIS 205 may reflect the feedback message in a direction of the base station 105-a based on an uplink reflection angle of the RIS 205. In some aspects, the feedback message may be an uplink control information (UCI) message, a MAC control element (CE), or an RRC message.

In some examples, the RIS 205 may provide increased spatial diversity, beamforming gain, and cell coverage. For example, if the direct communication link 215 between the base station 105-a and the UE 115-a is obstructed, the base station 105-a may use the communication link 210 to maintain communications with the UE 115-a via the RIS 205. As such, the RIS 205 may provide spatial diversity that enables the UE 115-a and the base station 105-a to mitigate interference, obstructions, and fluctuating channel conditions. Thus, the RIS 205 may increase reliability of communications between the base station 105-a and the UE 115-a.

In some examples, the RIS configuration message 220 may be an RRC message. In some such examples, the RRC message may indicate, to the UE 115-a, configuration information for one or more RISs 205 in the network. For example, the RRC message may include a field indicating a RIS location, a field indicating an uplink RIS reflection angle, a field indicating a downlink RIS reflection angle, a field indicating a RIS reflection angle (e.g., if the RIS reflection behavior is reciprocal between uplink and downlink), a field indicating a RIS identifier, or some combination thereof. In some examples, the RRC message may include a set of fields indicating RIS locations, a set of fields indicating uplink RIS reflection angles, a set of fields indicating downlink RIS reflection angles, a set of fields indicating reciprocal RIS reflection angles, a set of fields indicating RIS identifiers, or some combination thereof to support indicating configurations for multiple RISs 205. The fields may include bit values indicating absolute values (e.g., absolute positions, absolute uplink reflection angles, absolute downlink reflection angles), relative values (e.g., relative positions, relative uplink reflection angles, relative downlink reflection angles), or some combination thereof. In some aspects, the UE 115-a may receive the RRC message directly from the base station 105-a or via a RIS 205. Based on the RRC message, the UE 115-a may select a RIS 205 from the one or more RISs 205 and utilize the selected RIS 205 to facilitate communications with the base station 105-a.

In some other examples, the RIS configuration message 220 may be a MAC CE. In some such examples, the MAC CE may indicate, to the UE 115-a, configuration information for one or more RISs 205 in the network. For example, the MAC CE message may include a field indicating a RIS location, a field indicating an uplink RIS reflection angle, a field indicating a downlink RIS reflection angle, a field indicating a reciprocal RIS reflection angle (e.g., for both uplink and downlink), a field indicating a RIS identifier, or some combination thereof. In some examples, the RRC message may include a set of fields indicating RIS locations, a set of fields indicating uplink RIS reflection angles, a set of fields indicating downlink RIS reflection angles, a set of fields indicating reciprocal RIS reflection angles, a set of fields indicating RIS identifiers, or some combination thereof to support indicating configurations for multiple RISs 205 in the network. The fields may include bit values indicating absolute values (e.g., absolute positions, absolute uplink reflection angles, absolute downlink reflection angles), relative values (e.g., relative positions, relative uplink reflection angles, relative downlink reflection angles), or some combination thereof. In some aspects, the UE 115-a may receive the MAC CE message directly from the base station 105-a or via a RIS 205. Based on the MAC CE message, the UE 115-a may select a RIS 205 from the one or more RISs 205 and utilize the selected RIS 205 to facilitate communications with the base station 105-a.

In yet some other examples, the RIS configuration message 220 may be a downlink control information (DCI) message. In some such examples, the DCI message may allocate, to the UE 115-a, a specific RIS 205 for communications. For example, the DCI message may schedule the UE 115-a for communications. The DCI message may allocate time resources, frequency resources, and RIS resources (e.g., a specific RIS 205 or one or more specific elements of a RIS 205) for a specific communication (e.g., receiving a downlink message, transmitting an uplink message, communicating a sidelink message, or any other communication). In some examples, the DCI message may explicitly indicate the RIS 205 in a RIS identifier field. In some other examples, the DCI message may implicitly indicate the RIS 205 based on an association between the RIS 205 and a set of time resources, a set of frequency resources, or both. In yet some other examples, the DCI message may implicitly indicate the time resources, the frequency resources, or both based on an indicated RIS 205 and an association between the RIS 205 and time resources, frequency resources, or both. Additionally or alternatively, the DCI message may include one or more fields indicating a location, an uplink reflection angle, a downlink reflection angle, a reciprocal reflection angle (e.g., for both uplink and downlink), or a combination thereof for the allocated RIS 205. In some aspects, the UE 115-a may receive the DCI message directly from the base station 105-a or via the specific RIS 205. Based on the DCI message, the UE 115-a may utilize the specific RIS 205 to facilitate the specific communication.

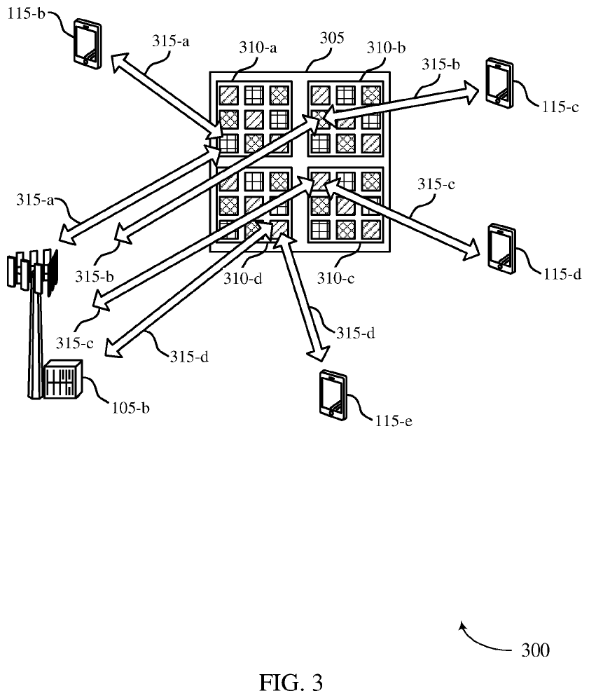

FIG. 3 illustrates an example of a wireless communications system 300 that supports communicating RIS information to support RDMA in accordance with aspects of the present disclosure. The wireless communications system 300 may implement aspects of the wireless communications systems 100 and 200. For example, the wireless communications system 300 may include a UE 115-b, a UE 115-c, a UE 115-d, a UE 115-e, and a base station 105-b, which may be examples of corresponding devices described herein with reference to FIGS. 1 and 2. In some aspects, the base station 105-b may communicate with the UE 115-b, the UE 115-c, the UE 115-d, and the UE 115-e via a RIS 305 using RDMA techniques.

In some cases, the base station 105-b may subdivide the RIS 305 into a set of co-located sub-RISs 310, where each sub-RIS 310 includes a subset of elements of the RIS 305. In some aspects, the term “RIS,” as used herein, may refer to a single RIS, multiple RISs acting as a single entity, a sub-RIS, a RIS including multiple sub-RISs, or a combination thereof. In some examples, the subset of elements for each sub-RIS 310 may include elements that are distributed throughout the RIS 305. For example, the elements included in a sub-RIS 310-a may not be adjacent elements. In some aspects, a respective sub-RIS 310 may be assigned to a specific UE 115. For example, the sub-RIS 310-a may be assigned to the UE 115-b, a sub-RIS 310-b may be assigned to the UE 115-c, a sub-RIS 310-c may be assigned to the UE 115-d, and a sub-RIS 310-d may be assigned to the UE 115-e. That is, the elements of the RIS 305 may be partitioned into subsets, with each subset serving a different UE 115. In some cases, a subset of the RIS 305 may not serve any UE 115 for a time period, and the base station 105-b may assign the subset to a UE 115 upon a UE 115 accessing the network and facilitating communications with the base station 105-b via the RIS 305.

In some systems, the UEs 115 may use respective sub-RISs 310 to facilitate communications with the base station 105-b. For example, the UE 115-b may communicate with the base station 105-b over a communication link 315-a that is facilitated by the sub-RIS 310-a, the UE 115-c may communicate with the base station 105-b over a communication link 315-b that is facilitated by the sub-RIS 310-b, the UE 115-d may communicate with the base station 105-b over a communication link 315-c that is facilitated by the sub-RIS 310-c, and the UE 115-e may communicate with the base station 105-b over a communication link 315-d that is facilitated by the sub-RIS 310-d.

In some aspects, each sub-RIS 310 may be associated with a configuration that includes a location, an uplink reflection angle, a downlink reflection angle, a set of elements of a RIS 305, or some combination thereof. The base station 105-b may transmit, to each UE 115, an indication of a configuration for a sub-RIS 310 that has been assigned to the respective UE 115. For example, the base station 105-b may transmit, to the UE 115-c, an indication of a configuration for the sub-RIS 310-b. In some aspects, the base station 105-b may indicate a relative location of a sub-RIS 310, a relative uplink reflection angle of a sub-RIS 310, a relative downlink reflection angle of a sub-RIS 310, or a combination thereof. For example, the base station 105-b may transmit, to the UE 115-d, an indication of a location of the sub-RIS 310-c relative to a location of the sub-RIS 310-b. Similarly, the base station 105-b may transmit an indication of an uplink reflection angle of the sub-RIS 310-c relative to an uplink reflection angle of the sub-RIS 310-b, an indication of a downlink reflection angle of the sub-RIS 310-c relative to a downlink reflection angle of the sub-RIS 310-b, or both. As such, the base station 105-b may avoid explicitly indicating locations, uplink reflection angles, downlink reflection angles, or a combination thereof for each sub-RIS 310. For example, rather than indicating a location, an uplink reflection angle, and a downlink reflection angle for each sub-RIS 310 in a configuration message, the base station 105-b may indicate a location, an uplink reflection angle, and a downlink reflection angle for a first sub-RIS 310-a and may indicate a gradient value for the locations, uplink reflection angles, and downlink reflection angles of other sub-RISs 310. In addition to a location, an uplink reflection angle, a downlink reflection angle, or a combination thereof, the base station 105-b may also transmit, to each UE 115, an identifier for the sub-RIS 310 assigned to each respective UE 115. For example, the base station 105-b may transmit, to the UE 115-e, an identifier, an uplink reflection angle, a downlink reflection angle, and a location corresponding to the sub-RIS 310-d. As such, if the UE 115-e changes locations, the UE 115-e may continue to beamform towards the sub-RIS 310-d based on using the received RIS identifier, uplink reflection angle, downlink reflection angle, and location corresponding to the sub-RIS 310-d.

In some examples, the base station 105-b may independently configure each sub-RIS 310 based on a respective UE 115 to which each sub-RIS 310 is assigned. For example, based on a location of the UE 115-c and a location of the sub-RIS 310-b, the base station 105-b may configure the sub-RIS 310-b with a first configuration so that the sub-RIS 310-b deflects communications between the UE 115-c and the base station 105-b. Based on a location of the UE 115-d and a location of the sub-RIS 310-c, the base station may configure the sub-RIS 310-c with a second configuration so that the sub-RIS 310-c deflects communications between the UE 115-d and the base station 105-b. Accordingly, the base station 105-b may configure the sub-RIS 310-b and the sub-RIS 310-c with different configurations (e.g., different uplink reflection angles, different downlink reflection angles, or both) so that the base station 105-b can communicate with both the UE 115-c and the UE 115-d via the RIS 305. As such, the base station 105-b may perform RDMA by using the RIS 305 to multiplex the UEs 115.

In some examples, during an initial access procedure between the base station 105-b and the UEs 115, the base station 105-b may indicate a TDM communication scheme for the RIS 305. Specifically, the base station 105-b may indicate that an uplink reflection angle of the RIS 305, a downlink reflection angle of the RIS 305, or both are time-dependent. That is, the RIS 305 may have different uplink reflection angles, different downlink reflection angles, or both in different symbols, sub-slots, slots, subframes, frames, or some combination thereof. Accordingly, the base station 105-b may provide, to the UEs 115, explicit scheduling information for communicating via the RIS 305. For example, the base station 105-b may indicate, to the UE 115-b, one or more time and frequency resources that the UE 115-b may use to communicate with the base station 105-b. In some aspects, the base station 105-b may indicate the explicit scheduling information using a DCI message. In some examples, the base station 105-b may allocate a specific RIS 305, sub-RIS 310, or both to the UE 115 along with the time and frequency resources. In some other examples, the UE 115 may determine the RIS 305, sub-RIS 310, or both based on the allocated time resources and the TDM configuration of the RIS 305, sub-RIS 310, or both. In some cases, the base station 105-b may assign the same RIS 305 or sub-RIS 310 to multiple UEs 115 in a TDM fashion.

In some examples, subdividing the RIS 305 into multiple sub-RISs 310 may reduce the complexity of performing RDMA. For example, if the UE 115-e changes locations, the base station 105-b may reconfigure the sub-RIS 310-d to account for the location change of the UE 115-e rather than reconfiguring the entire RIS 305. As such, subdividing the RIS 305 may reduce the processing power associated with performing RDMA for moving UEs 115. If, for example, the UE 115-b departs from the network or powers off after communicating with the base station 105-b via the sub-RIS 310-a, the base station 105-b may reconfigure the sub-RIS 310-a accordingly instead of reconfiguring the entire RIS 305. For example, if a new UE 115 connects with the base station 105-b, the base station 105-b may reconfigure the sub-RIS 310-a—previously assigned to the UE 115-b—to facilitate communications between the new UE 115 and the base station 105-b. Thus, subdividing the RIS 305 may also reduce the processing power associated with performing RDMA for UEs 115 connecting to and disconnecting from the network.

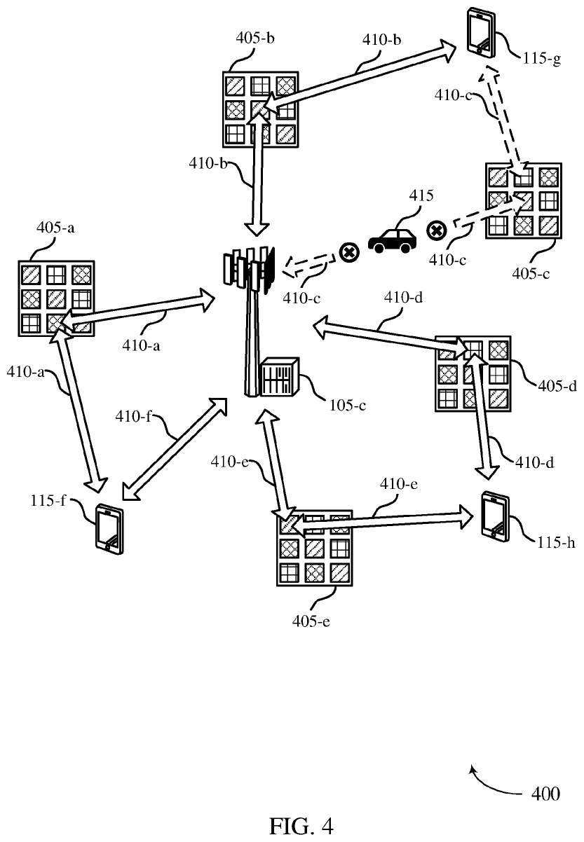

FIG. 4 illustrates an example of a wireless communications system 400 that supports communicating RIS information to support RDMA in accordance with aspects of the present disclosure. The wireless communications system 400 may implement aspects of the wireless communications systems 100, 200, and 300. For example, the wireless communications system 400 may include a UE 115-f, a UE 115-g, a UE 115-h, and a base station 105-c, which may be examples of corresponding devices described herein with reference to FIGS. 1 through 3. In some examples, in addition or alternative to subdividing a RIS into multiple co-located sub-RISs as described with reference to FIG. 3, the base station 105-c may use multiple, spatially distributed RISs 405 to communicate with UEs 115 via RDMA.

In some systems, the base station 105-c may use multiple RISs 405 to communicate with one or more UEs 115. That is, a UE 115 may be associated with one or more RISs 405. For example, the UE 115-h may be associated with a RIS 405-d and a RIS 405-e such that the UE 115-h may communicate with the base station 105-c over a communication link 410-d that uses the RIS 405-d, a communication link 410-e that uses the RIS 405-e, or both. If, for example, the communication link 410-d between the base station 105-c and the UE 115-h is obstructed, experiences interference, or otherwise drops below a quality or signal strength threshold, the UE 115-h may use the RIS 405-e to maintain communication with the base station 105-c via the communication link 410-e. Additionally or alternatively, if another UE 115 is located proximate to the UE 115-h (e.g., within a threshold distance), the UE 115-h and the proximate UE 115 may use different RISs 405 to spatially differentiate signals between these UEs 115 and the base station 105-c. Thus, utilizing multiple distributed RISs 405 may enhance spatial diversity for communications between the base station 105-c and the UEs 115.

Additionally or alternatively, the base station 105-c may communicate with a UE 115 via a direct communication link or via a communication link that is facilitated by a RIS 405. For example, the UE 115-f may communicate with the base station 105-c over a direct communication link 410-f. However, if conditions of the direct communication link 410-f deteriorate (e.g., due to interference or blockage), the UE 115-f may maintain communication with the base station 105-c over a communication link 410-a that is facilitated by a RIS 405-a. Hence, in comparison to using a single RIS, using multiple distributed RISs 405 may offer greater spatial diversity. Further, the base station 105-c may generate dynamic spatial dimensions based on activating or deactivating RISs 405. For example, if the RIS 405-b is in a deactivated state and the communication link 410-c between the base station 105-c and the UE 115-g is obstructed (e.g., by an obstruction 415), the base station 105-c may activate the RIS 405-b and communicate with the UE 115-g over the communication link 410-b using the RIS 405-b.

In some examples, the base station 105-c may transmit, to a UE 115, configuration information for multiple distributed RISs 405. For example, the base station 105-c may transmit, to the UE 115-g, configuration information for a RIS 405-b and a RIS 405-c. Additionally or alternatively, the configuration information may indicate other RISs 405 in the network, such as a RIS 405-a, a RIS 405-d, and a RIS 405-e. The configuration information may include locations, uplink reflection angles, downlink reflection angles, or a combination thereof for the RISs 405. In some examples, the UE 115-g may select, based on the configuration information and locations corresponding to the UE 115-g, the base station 105-c, the RIS 405-b, and the RIS 405-c, whether to facilitate communications with the base station 105-c directly, via the RIS 405-b, or via the RIS 405-c. Additionally or alternatively, the selection may be based on reference signal measurements (e.g., RSSI, RSRP, RSRQ) associated with the RIS 405-b, the RIS 405-c, a direct link, or a combination thereof. If, for example, the UE 115-g determines that a communication link 410-c corresponding to the RIS 405-c is experiencing interference or a deterioration in channel conditions (e.g., a low RSSI below an RSSI threshold), the UE 115-c may refrain from selecting the RIS 405-c.

In some examples, a UE 115 may transmit, to the base station 105-c, a feedback message indicating a selection of one or more of the multiple distributed RISs 405. If, for example, the UE 115-g receives configuration information for the RIS 405-a, the RIS 405-b, the RIS 405-c, the RIS 405-d, and the RIS 405-e, the feedback message may indicate the RIS 405-b, the RIS 405-c, or both selected by the UE 115-g to facilitate communications between the UE 115-g and the base station 105-c. In some examples, the feedback message may also include channel state information (CSI) associated with one or more RISs 405. Based on the feedback message, the base station 105-c may assign one or more RISs 405 to the UE 115 such that the UE 115 may use a selected RIS 405 to facilitate communications with the base station 105-c.

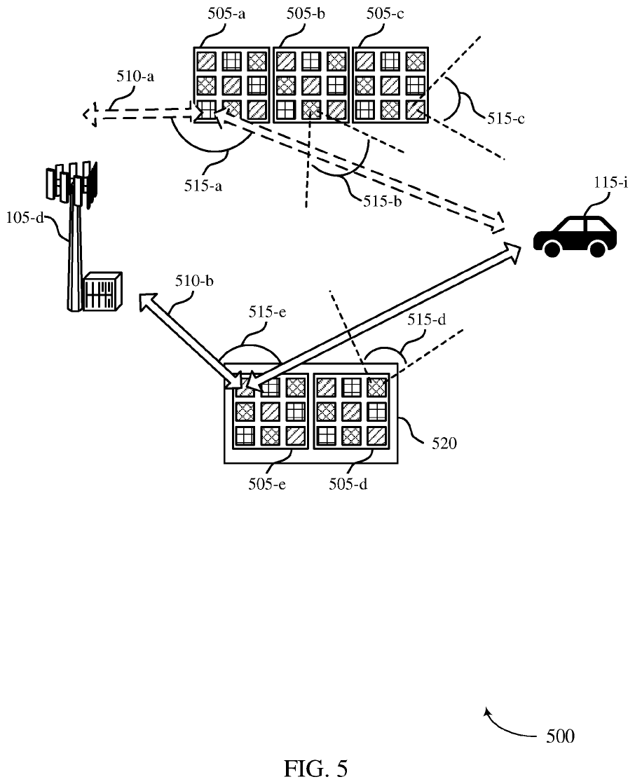

FIG. 5 illustrates an example of a wireless communications system 500 that supports communicating RIS information to support RDMA in accordance with aspects of the present disclosure. The wireless communications system 500 may implement aspects of the wireless communications systems 100, 200, 300, and 400. For example, the wireless communications system 500 may include a UE 115-i and a base station 105-d, which may be examples of corresponding devices described herein with reference to FIGS. 1 through 4. In some aspects, the UE 115-i may move and may perform a handover between nearby RISs 505 based on updated location information for the UE 115-i and configuration information for the nearby RISs 505.

In some examples, the UE 115-i may be a vehicle (e.g., a smart vehicle) in a V2X communication system. The movement of the UE 115-i may alter channel conditions of a communication link 510 between the UE 115-i and the base station 105-d. For example, the UE 115-i may use a RIS 505-a to communicate with the base station 105-d via a communication link 510-a. The RIS 505-a may be configured with reflection angles 515-a. In some aspects, the reflection angles 515-a may include an uplink reflection angle, a downlink reflection angle, or both. As the UE 115-i moves, signals transmitted by the UE 115-i and reflected by the RIS 505-a may fail to reach the base station 105-d (e.g., based on the reflection angles 515-a and the new location of the UE 115-i). As such, if the UE 115-i moves to a new location, the UE 115-i may receive reflected signals from the base station 105-d with reduced signal quality. That is, the reflection angles 515-a of the RIS 505-a may not properly reflect signals from the base station 105-d to the new location of the UE 115-i and vice versa.

However, as described herein with reference to FIG. 4, the UE 115-i may have access to configuration information for other RISs 505 in the network. In some aspects, the configuration information may include locations and reflection angles 515 for nearby RISs 505. In some other aspects, the reflection angles 515 may include uplink reflection angles, downlink reflection angles, or both. For example, the configuration information may include a location and reflection angles 515-a for a RIS 505-a, a location and reflection angles 515-b for a RIS 505-b, a location and reflection angles 515-c for a RIS 505-c, a location and reflection angles 515-d for a RIS 505-d, and a location and reflection angles 515-e for a RIS 505-e. In some examples, the reflection angles 515 of a RIS 505 may be based on a relationship (e.g., a mapping) between an angle of arrival (AoA) and an angle of departure (AoD) of signals reflected by the RIS 505. For example, if a signal arrives at the RIS 505-d with an AoA of 30 degrees and the RIS 505-d has a reflection angle of 110 degrees, the signal may depart from the RIS 505-d with an AoD of 40 degrees. Specifically, the signal deflection may be based on Equation 1. In some aspects, the relationship between the AoA and the AoD for a RIS 505 may be different in uplink and downlink (e.g., the reflection behavior of the RIS 505 may not be reciprocal). As such, the reflection angles 515 of the RIS 505 may indicate an uplink reflection angle, a downlink reflection angle, or both. In some other aspects, the relationship between the AoA and the AoD for a RIS 505 may be the same in uplink and downlink (e.g., the reflection behavior of the RIS 505 may be reciprocal). As such, the reflection angles 515 of the RIS 505 may indicate a single reflection angle. Equation 1 may correspond to uplink reflections, downlink reflections, or both.

AoD=(180°−Reflection Angle)−AoA (1)

In some examples, the base station 105-d may indicate, to the UE 115-i, explicit reflection angle mappings between an AoA and an AoD for a specific RIS 505. In some other examples, the base station 105-d may indicate relative reflection angle mappings (e.g., gradients) for the specific RIS 505 based on reflection angle mappings for another RIS 505. Similarly, the base station 105-d may indicate a relative location of the specific RIS 505 based on a location of another RIS 505. For example, the RIS 505-d and the RIS 505-e may be subsets of a larger RIS 520 (e.g., the RIS 505-d and the RIS 505-e may be sub-RISs of a total larger RIS 520). The base station 105-d may indicate, to the UE 115-i, configuration information for the larger RIS 520 based on relative configurations for the subsets. That is, the base station 105-d may indicate the reflection angles 515-e for the RIS 505-e as gradients of (e.g., offsets from) the reflection angles 515-d for the RIS 505-d and may indicate the location of the RIS 505-e relative to the location of the RIS 505-d. As such, by knowing the reflection angles 515-d and the gradients, the UE 115-i may determine the absolute reflection angles 515-e for the RIS 505-e. Similarly, by knowing the location of the RIS 505-d and a relative location of the RIS 505-e relative to the RIS 505-d, the UE 115-i may determine the absolute location of the RIS 505-e. Thus, the base station 105-d may refrain from transmitting explicit configuration information for each subset of a larger RIS 520, thereby avoiding the signaling overhead associated with transmitting such explicit configuration information. In some examples, the base station 105-d may use similar techniques to indicate relative information for separate RISs 505 that are not part of a larger RIS 520.

Based on the configuration information, the UE 115-i may determine which RIS 505 is configured to reflect signals between the new location of the UE 115-i and the base station 105-d more effectively than the RIS 505-a. Thus, the UE 115-i may perform a handover procedure from the RIS 505-a to one of the other nearby RISs 505. For example, the UE 115-i may determine, based on previously acquired configuration information, that the RIS 505-e is configured with reflection angles 515-e that reflect communications between the base station 105-d and the UE 115-i at the new location more effectively than the RIS 505-a. Based on this determination, the UE 115-i may perform a handover procedure from the RIS 505-a to the RIS 505-e. In some aspects, the UE 115-i may perform the handover procedure without an input from the base station 105-d. For example, the base station 105-d may not be involved in the handover procedure. Such a handover procedure may be transparent to the base station 105-d, or the UE 115-i may transmit an indication of the handover to the base station 105-d. Responsive to performing the handover procedure, the UE 115-i may use the RIS 505-e to communicate with the base station 105-d via the communication link 510-b. In some other aspects, the base station 105-d may trigger the RIS handover for the UE 115-i, or the UE 115-i may request—and the base station 105-d may confirm-a RIS handover.

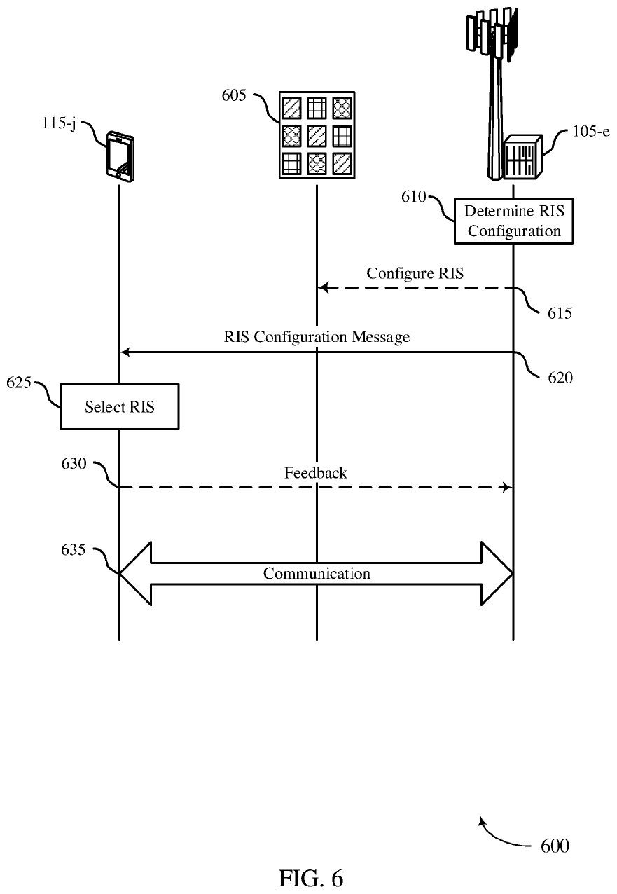

FIG. 6 illustrates an example of a process flow 600 that supports communicating RIS information to support RDMA in accordance with aspects of the present disclosure. The process flow 600 may implement aspects of the wireless communications systems 100, 200, 300, 400, and 500. For example, the process flow 600 illustrates communications between a UE 115-j and a base station 105-e, which may be examples of corresponding devices described herein. In some examples, the base station 105-e may determine a configuration for a RIS 605 and may transmit a RIS configuration message to the UE 115-j. In response to the RIS configuration message, the UE 115-j may select the RIS 605 to facilitate communications between the UE 115-j and the base station 105-e. Based on selecting the RIS 605, the base station 105-e and the UE 115-j may communicate via the RIS 605. Additionally, alternative examples of the following may be implemented, where some operations may be performed in a different order than described or are not performed at all. In some cases, operations may include additional features not mentioned below, or further processes or communications may be added.

At 610, the base station 105-e may determine a configuration of the RIS 605. In some aspects, the base station 105-e may determine the configuration based on configuring an uplink reflection angle of the RIS 605, configuring a downlink reflection angle of the RIS 605, or both. In some examples, the RIS 605 may include a first sub-RIS of a total RIS. In such examples, the base station 105-e may configure the first sub-RIS relative to a second sub-RIS of the total RIS. In some aspects, the base station 105-e may determine the configuration of the RIS 605 based on a location of the UE 115-j, a location of the base station 105-e, a reference signal measurement associated with the RIS 605, or a combination thereof.

In some aspects, at 615, the base station 105-e may configure the RIS 605 according to the determined configuration. In some examples, if the RIS 605 includes multiple elements, the base station 105-e may configure respective uplink reflection angles, respective downlink reflection angles, or both for the multiple elements. In such examples, the base station 105-e may configure the respective uplink reflection angles, the respective downlink reflection angles, or both as explicit angles or relative angles relative to reflection angles of another element. In some other examples, the base station 105-e may activate or deactivate the RIS 605. Based on being configured by the base station 105-e, the RIS 605 may adjust one or more elements according to the determined configuration.

At 620, the base station 105-e may transmit, to the UE 115-j, a RIS configuration message indicating a configuration of the RIS 605. The base station 105-e may transmit the RIS configuration message directly to the UE 115-j or may transmit the RIS configuration message to the UE 115-j via a RIS 605. In some cases, the base station 105-e may broadcast the RIS configuration message to a set of UEs 115. In some examples, if the RIS 605 includes multiple elements, the RIS configuration message may assign the UE 115-j a subset of the multiple elements to facilitate communications with the base station 105-e. Additionally or alternatively, the RIS configuration message may assign the RIS 605 to the UE 115-j for a set of time resources, a set of frequency resources, or both. In some aspects, the configuration of the RIS 605 may include a location of the RIS 605, an uplink reflection angle of the RIS 605, a downlink reflection angle of the RIS 605, or a combination thereof. If the RIS 605 is a sub-RIS of a total RIS, the location of the RIS 605 may include a relative location of the sub-RIS relative to a second sub-RIS of the total RIS, a relative uplink reflection angle of the sub-RIS relative to a second sub-RIS of the total RIS, a relative downlink reflection angle of the sub-RIS relative to a second sub-RIS of the total RIS, or a combination thereof. In some examples, the RIS configuration message may be a DCI message, an RRC message, a MAC CE, or a combination thereof. Additionally or alternatively, the RIS configuration message may include multiple configurations for multiple RISs in a wireless network. In some aspects, the base station 105-e may transmit the RIS configuration message based on receiving a feedback message from the UE 115-j.

At 625, the UE 115-j may select the RIS 605 to facilitate communications with the base station 105-e based on the configuration of the RIS 605. In some examples, if the UE 115-j receives configuration information (e.g., locations, uplink reflection angles, and downlink reflection angles) for multiple RISs in the wireless network, the UE 115-j may select the RIS 605 from the multiple RISs based on a position of the UE 115-j, a position of the base station 105-e, a position of the RIS 605 indicated by the configuration of the RIS 605, an uplink reflection angle of the RIS 605 indicated by the configuration of the RIS 605, a downlink reflection angle of the RIS 605 indicated by the configuration of the RIS 605, a reference signal measurement associated with the RIS 605, or a combination thereof.

In some examples, at 630, the UE 115-j may transmit, to the base station 105-e, a feedback message indicating the selected RIS 605. In some examples, the feedback message may include CSI associated with the RIS 605. In some aspects, the UE 115-j may transmit the feedback message to the base station 105-e via the RIS 605. Alternatively, the UE 115-j may transmit the feedback message to the base station 105-e over a direct communication link. In some examples, the feedback message may indicate that the UE 115-j has performed a handover procedure from a different RIS in the wireless network to the RIS 605.

At 635, the UE 115-j and the base station 105-e may communicate via the RIS 605. In some examples, both the UE 115-j and the base station 105-e may perform a beamforming operation in a direction corresponding to the RIS 605. For example, rather than performing beamforming towards the base station 105-e or performing beamforming in all directions, the UE 115-j may conserve power by beamforming in the direction of the RIS 605. Based on the beamforming operation, the UE 115-j and the base station 105-e may select communication beams and may communicate via the RIS 605 using the selected communication beams (e.g., beams directed towards the RIS 605). In some aspects, if the RIS 605 includes multiple elements, the UE 115-j may communicate with the base station 105-e via a subset of the multiple elements. Additionally or alternatively, if the RIS 605 is assigned to the UE 115-j for a set of resources (e.g., time resources, frequency resources, or both), the UE 115-j may communicate with the base station 105-e via the RIS 605 in the assigned resources. In some examples, the base station 105-e may communicate with the UE 115-j via the RIS 605 based on receiving a feedback message from the UE 115-j, based on activating the RIS 605, or both.

In some systems, the base station 105-e may also communicate with a second UE 115 via the RIS 605. If, for example, the RIS 605 includes multiple elements, the base station 105-e may communicate with the UE 115-j via a first subset of the multiple elements of the RIS 605 and may communicate with the second UE 115 via a second subset of the multiple elements of the RIS 605. In some examples, if the UE 115-j leaves the wireless network and the base station 105-e detects a third UE 115 accessing the wireless network, the base station 105-e may reassign the first subset of the multiple elements of the RIS 605 to the third UE 115 based on the third UE 115 accessing the wireless network and the UE 115-j leaving the wireless network.

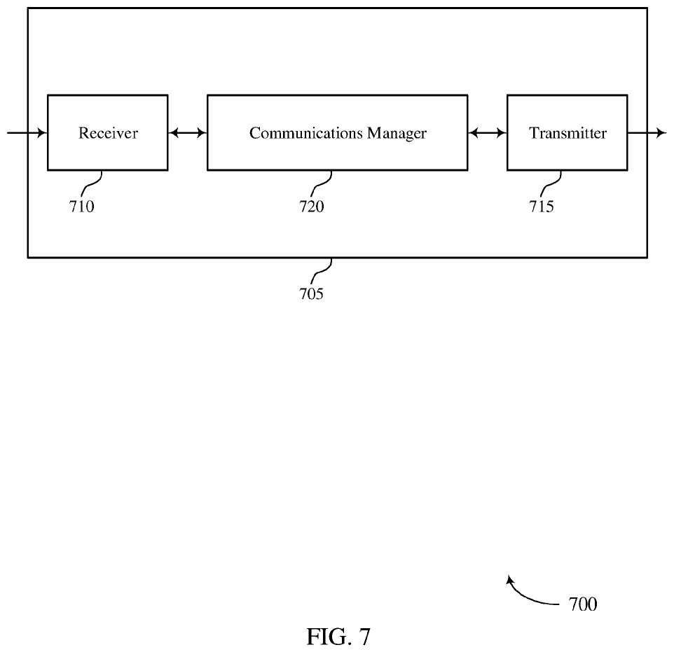

FIG. 7 shows a block diagram 700 of a device 705 that supports communicating RIS information to support RDMA in accordance with aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or a combination thereof associated with various information channels (e.g., control channels, data channels, information channels related to communicating RIS information to support RDMA). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or a combination thereof associated with various information channels (e.g., control channels, data channels, information channels related to communicating RIS information to support RDMA). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of communicating RIS information to support RDMA as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or a combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a UE in accordance with examples as disclosed herein. For example, the communications manager 720 may be configured as or otherwise support a means for receiving, from a base station, a message indicating a configuration of a RIS. The communications manager 720 may be configured as or otherwise support a means for selecting the RIS to facilitate communications with the base station based on the configuration of the RIS. The communications manager 720 may be configured as or otherwise support a means for communicating with the base station via the RIS based on the selecting.

By including or configuring the communications manager 720 in accordance with examples as described herein, the device 705 (e.g., a processor controlling or otherwise coupled to the receiver 710, the transmitter 715, the communications manager 720, or a combination thereof) may support techniques for reduced processing, reduced power consumption, and more efficient utilization of communication resources. For example, the communications manager 720, based on implementing the techniques described herein, may receive configuration information for a RIS such that the communications manager 720, or one or more processing components of the communications manager 720, can use the RIS to exchange communications with increased reliability. As such, the communications manager 720 may request and transmit fewer retransmissions and may enter a sleep mode for longer durations or more frequently, which may result in improved power savings and increased battery life of the device 705.

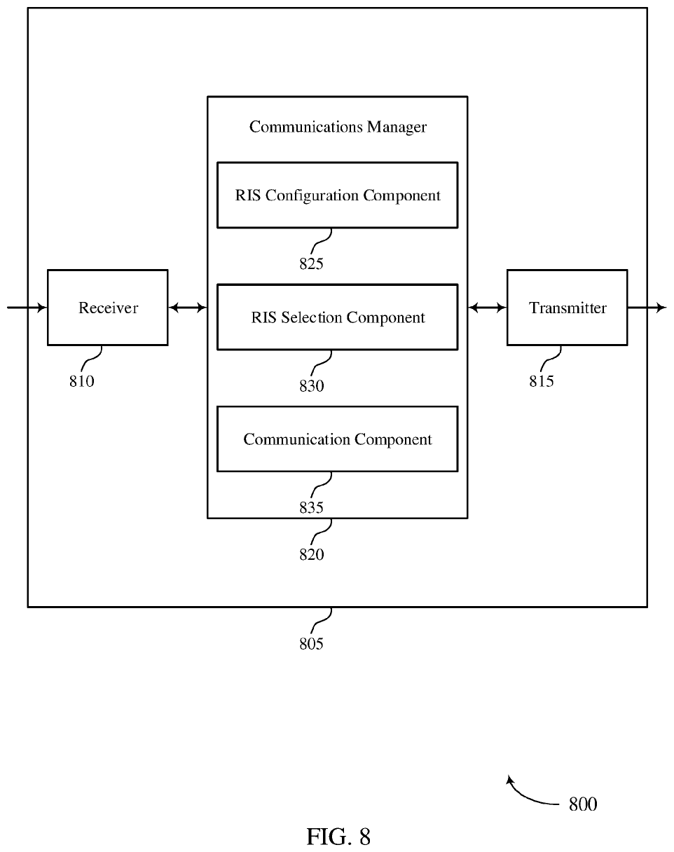

FIG. 8 shows a block diagram 800 of a device 805 that supports communicating RIS information to support RDMA in accordance with aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or a combination thereof associated with various information channels (e.g., control channels, data channels, information channels related to communicating RIS information to support RDMA). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or a combination thereof associated with various information channels (e.g., control channels, data channels, information channels related to communicating RIS information to support RDMA). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of communicating RIS information to support RDMA as described herein. For example, the communications manager 820 may include a RIS configuration component 825, a RIS selection component 830, a communication component 835, or a combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communications at a UE in accordance with examples as disclosed herein. The RIS configuration component 825 may be configured as or otherwise support a means for receiving, from a base station, a message indicating a configuration of a RIS. The RIS selection component 830 may be configured as or otherwise support a means for selecting the RIS to facilitate communications with the base station based on the configuration of the RIS. The communication component 835 may be configured as or otherwise support a means for communicating with the base station via the RIS based on the selecting.

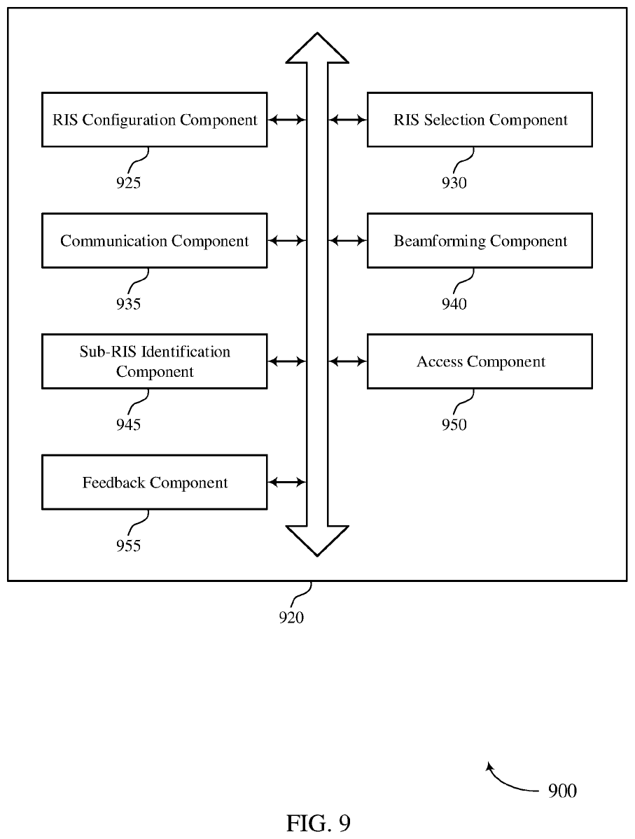

FIG. 9 shows a block diagram 900 of a communications manager 920 that supports communicating RIS information to support RDMA in accordance with aspects of the present disclosure. The communications manager 920 may be an example of aspects of a communications manager 720, a communications manager 820, or both, as described herein. The communications manager 920, or various components thereof, may be an example of means for performing various aspects of communicating RIS information to support RDMA as described herein. For example, the communications manager 920 may include a RIS configuration component 925, a RIS selection component 930, a communication component 935, a beamforming component 940, a sub-RIS identification component 945, an access component 950, a feedback component 955, or a combination thereof. Each of these components may communicate, directly or indirectly, with one another (e.g., via one or more buses).

The communications manager 920 may support wireless communications at a UE in accordance with examples as disclosed herein. The RIS configuration component 925 may be configured as or otherwise support a means for receiving, from a base station, a message indicating a configuration of a RIS. The RIS selection component 930 may be configured as or otherwise support a means for selecting the RIS to facilitate communications with the base station based on the configuration of the RIS. The communication component 935 may be configured as or otherwise support a means for communicating with the base station via the RIS based on the selecting.

In some examples, to support communicating with the base station via the RIS, the beamforming component 940 may be configured as or otherwise support a means for performing a beamforming operation in a direction corresponding to the RIS. In some examples, to support communicating with the base station via the RIS, the beamforming component 940 may be configured as or otherwise support a means for selecting a communication beam based on the beamforming operation. In some examples, to support communicating with the base station via the RIS, the communication component 935 may be configured as or otherwise support a means for communicating with the base station via the RIS using the selected communication beam.

In some examples, the RIS includes a set of multiple elements, and the sub-RIS identification component 945 may be configured as or otherwise support a means for determining a subset of elements of the set of multiple elements of the RIS based on the configuration of the RIS, where the communicating includes communicating with the base station via the subset of elements.

In some examples, the RIS includes a set of multiple elements, and the access component 950 may be configured as or otherwise support a means for accessing a wireless network including the base station, where the message is received based on accessing the wireless network and the message assigns the UE a subset of elements of the set of multiple elements of the RIS for communication.

In some examples, the message indicates a set of multiple configurations for a set of multiple RISs in a wireless network. In some examples, to support selecting the RIS, the RIS selection component 930 may be configured as or otherwise support a means for selecting the RIS of the set of multiple RISs for communication based on a position of the UE, a position of the base station, a position of the RIS indicated by the configuration of the RIS, an uplink reflection angle of the RIS indicated by the configuration of the RIS, a downlink reflection angle of the RIS indicated by the configuration of the RIS, a reference signal measurement associated with the RIS, or a combination thereof.

In some examples, the feedback component 955 may be configured as or otherwise support a means for transmitting, to the base station, a feedback message indicating the selected RIS. In some examples, the feedback message includes a CSI feedback message.

In some examples, the message assigns the RIS to the UE for a set of time resources, a set of frequency resources, or both. In some examples, the communicating includes communicating with the base station via the assigned RIS in the set of time resources, the set of frequency resources, or both.

In some examples, the configuration of the RIS indicates a set of time resources, a set of frequency resources, or both assigned to the RIS. In some examples, the configuration of the RIS includes a location of the RIS, an uplink reflection angle of the RIS, a downlink reflection angle of the RIS, or a combination thereof.

In some examples, the RIS includes a first sub-RIS of a total RIS. In some examples, the location of the RIS includes a relative location of the first sub-RIS relative to a second sub-RIS of the total RIS, the uplink reflection angle of the RIS includes a relative uplink reflection angle of the first sub-RIS relative to an uplink reflection angle of the second sub-RIS of the total RIS, the downlink reflection angle of the RIS includes a relative downlink reflection angle of the first sub-RIS relative to a downlink reflection angle of the second sub-RIS of the total RIS, or a combination thereof.

In some examples, the message includes a DCI message, an RRC configuration message, a MAC CE, or a combination thereof.

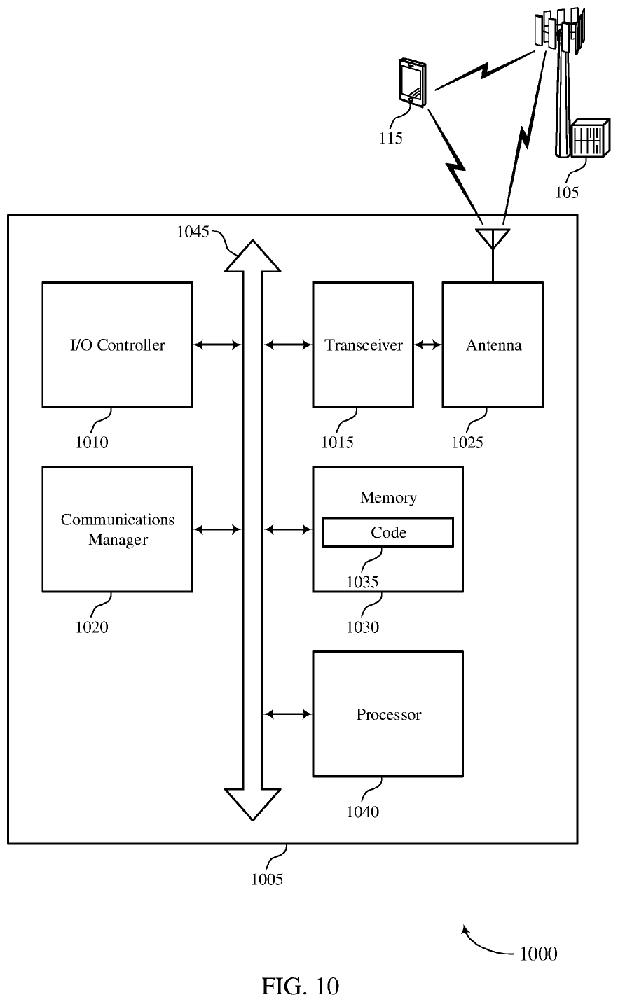

FIG. 10 shows a diagram of a system 1000 including a device 1005 that supports communicating RIS information to support RDMA in accordance with aspects of the present disclosure. The device 1005 may be an example of or include the components of a device 705, a device 805, or a UE 115 as described herein. The device 1005 may communicate wirelessly with one or more base stations 105, UEs 115, or a combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or a combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or a combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting communicating RIS information to support RDMA). For example, the device 1005 or a component of the device 1005 may include a processor 1040 and memory 1030 coupled to the processor 1040, the processor 1040 and memory 1030 configured to perform various functions described herein.

The communications manager 1020 may support wireless communications at a UE in accordance with examples as disclosed herein. For example, the communications manager 1020 may be configured as or otherwise support a means for receiving, from a base station, a message indicating a configuration of a RIS. The communications manager 1020 may be configured as or otherwise support a means for selecting the RIS to facilitate communications with the base station based on the configuration of the RIS. The communications manager 1020 may be configured as or otherwise support a means for communicating with the base station via the RIS based on the selecting.

By including or configuring the communications manager 1020 in accordance with examples as described herein, the device 1005 may support techniques for reduced processing, reduced power consumption, and more efficient utilization of communication resources. For example, the communications manager 1020 may, based on implementing the techniques described herein, receive configuration information for a RIS such that the communications manager 1020, or one or more processing components of the communications manager 1020, can use the RIS to communicate with a base station 105 with increased reliability. As such, the communications manager 1020 may request and transmit fewer retransmissions than communicating without the RIS, which may result in improved power savings and increased battery life of the device 1005.

In some examples, the communications manager 1020 may be configured to perform various operations (e.g., receiving, monitoring, transmitting) using or otherwise in cooperation with the transceiver 1015, the one or more antennas 1025, or a combination thereof. Although the communications manager 1020 is illustrated as a separate component, in some examples, one or more functions described with reference to the communications manager 1020 may be supported by or performed by the processor 1040, the memory 1030, the code 1035, or a combination thereof. For example, the code 1035 may include instructions executable by the processor 1040 to cause the device 1005 to perform various aspects of communicating RIS information to support RDMA as described herein, or the processor 1040 and the memory 1030 may be otherwise configured to perform or support such operations.

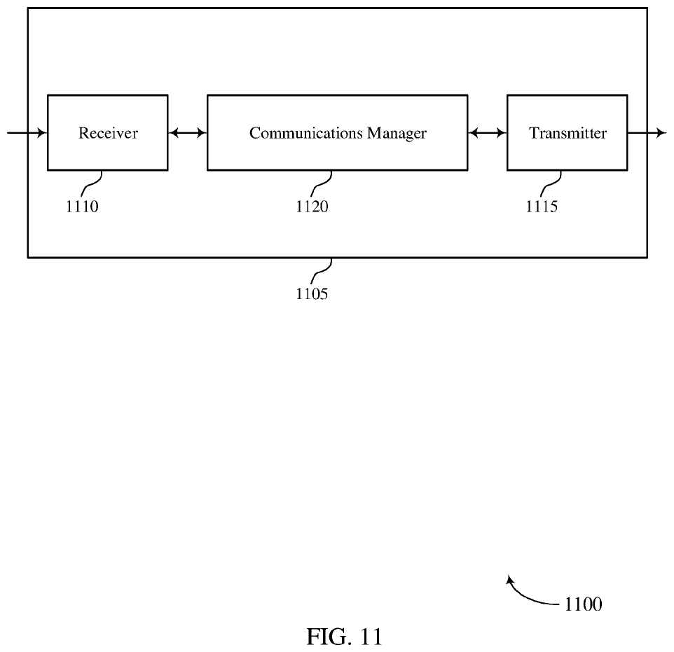

FIG. 11 shows a block diagram 1100 of a device 1105 that supports communicating RIS information to support RDMA in accordance with aspects of the present disclosure. The device 1105 may be an example of aspects of a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or a combination thereof associated with various information channels (e.g., control channels, data channels, information channels related to communicating RIS information to support RDMA). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or a combination thereof associated with various information channels (e.g., control channels, data channels, information channels related to communicating RIS information to support RDMA). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of communicating RIS information to support RDMA as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or a combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a base station in accordance with examples as disclosed herein. For example, the communications manager 1120 may be configured as or otherwise support a means for determining a configuration of a RIS. The communications manager 1120 may be configured as or otherwise support a means for transmitting, to a UE, a message indicating the configuration of the RIS. The communications manager 1120 may be configured as or otherwise support a means for communicating with the UE via the RIS based on the configuration of the RIS.

By including or configuring the communications manager 1120 in accordance with examples as described herein, the device 1105 (e.g., a processor controlling or otherwise coupled to the receiver 1110, the transmitter 1115, the communications manager 1120, or a combination thereof) may support techniques for reduced processing, reduced power consumption, and more efficient utilization of communication or processing resources. For example, based on implementing the described techniques, the communications manager 1120 may perform beamforming towards a RIS and may use the RIS to communicate with multiple UEs. As such, the communications manager 1120 may refrain from performing a beam sweeping procedure to determine a suitable beam for communications with each of the multiple UEs 115. Thus, implementing the described techniques may provide for more efficient processing and power usage at the device 1105. Further, if a first link between the device 1105 and a UE 115 is obstructed, experiences interference, or otherwise drops below a quality or signal strength threshold, the communications manager 1120 may communicate with the UE 115 over a second link facilitated by a RIS, thereby increasing the reliability of communications between the device 1105 and the UE 115.

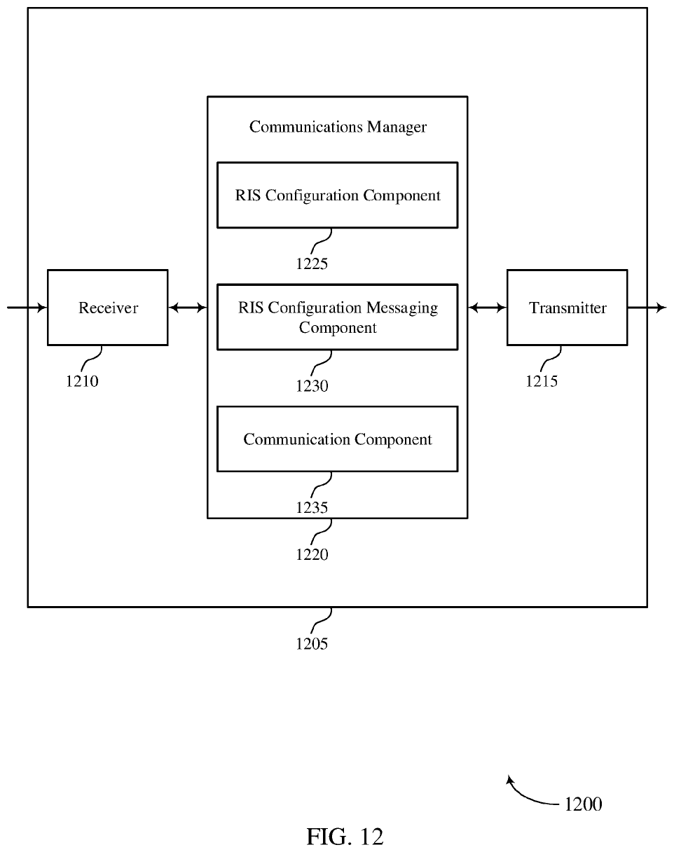

FIG. 12 shows a block diagram 1200 of a device 1205 that supports communicating RIS information to support RDMA in accordance with aspects of the present disclosure. The device 1205 may be an example of aspects of a device 1105 or a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or a combination thereof associated with various information channels (e.g., control channels, data channels, information channels related to communicating RIS information to support RDMA). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or a combination thereof associated with various information channels (e.g., control channels, data channels, information channels related to communicating RIS information to support RDMA). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of communicating RIS information to support RDMA as described herein. For example, the communications manager 1220 may include a RIS configuration component 1225, a RIS configuration messaging component 1230, a communication component 1235, or a combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communications at a base station in accordance with examples as disclosed herein. The RIS configuration component 1225 may be configured as or otherwise support a means for determining a configuration of a RIS. The RIS configuration messaging component 1230 may be configured as or otherwise support a means for transmitting, to a UE, a message indicating the configuration of the RIS. The communication component 1235 may be configured as or otherwise support a means for communicating with the UE via the RIS based on the configuration of the RIS.

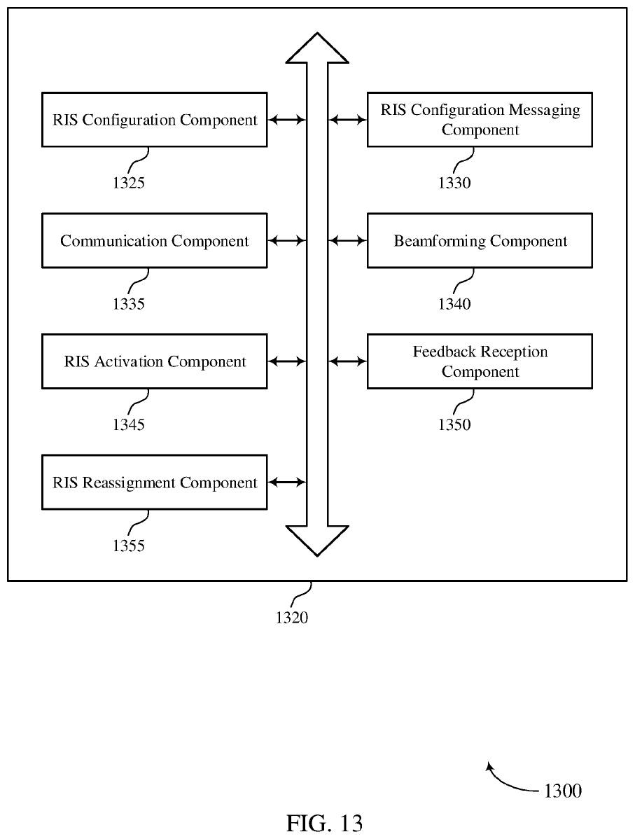

FIG. 13 shows a block diagram 1300 of a communications manager 1320 that supports communicating RIS information to support RDMA in accordance with aspects of the present disclosure. The communications manager 1320 may be an example of aspects of a communications manager 1120, a communications manager 1220, or both, as described herein. The communications manager 1320, or various components thereof, may be an example of means for performing various aspects of communicating RIS information to support RDMA as described herein. For example, the communications manager 1320 may include a RIS configuration component 1325, a RIS configuration messaging component 1330, a communication component 1335, a beamforming component 1340, a RIS activation component 1345, a feedback reception component 1350, a RIS reassignment component 1355, or a combination thereof. Each of these components may communicate, directly or indirectly, with one another (e.g., via one or more buses).

The communications manager 1320 may support wireless communications at a base station in accordance with examples as disclosed herein. The RIS configuration component 1325 may be configured as or otherwise support a means for determining a configuration of a RIS. The RIS configuration messaging component 1330 may be configured as or otherwise support a means for transmitting, to a UE, a message indicating the configuration of the RIS. The communication component 1335 may be configured as or otherwise support a means for communicating with the UE via the RIS based on the configuration of the RIS.

In some examples, to support communicating with the UE via the RIS, the beamforming component 1340 may be configured as or otherwise support a means for performing a beamforming operation in a direction corresponding to the RIS. In some examples, to support communicating with the UE via the RIS, the beamforming component 1340 may be configured as or otherwise support a means for selecting a communication beam based on the beamforming operation. In some examples, to support communicating with the UE via the RIS, the communication component 1335 may be configured as or otherwise support a means for communicating with the UE via the RIS using the selected communication beam.

In some examples, the message indicates a set of multiple configurations for a set of multiple RISs in a wireless network including the base station. In some examples, the feedback reception component 1350 may be configured as or otherwise support a means for receiving, from the UE, a feedback message indicating that the UE selected the RIS for communication, where communicating with the UE via the RIS is based on the feedback message. In some examples, the feedback message includes a CSI feedback message.

In some examples, the message assigns the RIS to the UE for a set of time resources, a set of frequency resources, or both. In some examples, the communicating includes communicating with the UE via the assigned RIS in the set of time resources, the set of frequency resources, or both.

In some examples, to support determining the configuration of the RIS, the RIS configuration component 1325 may be configured as or otherwise support a means for configuring an uplink reflection angle of the RIS, a downlink reflection angle of the RIS, or both, where the configuration of the RIS includes the uplink reflection angle of the RIS, the downlink reflection angle of the RIS, or both.

In some examples, to support configuring the uplink reflection angle of the RIS, the downlink reflection angle of the RIS, or both, the RIS configuration component 1325 may be configured as or otherwise support a means for transmitting a configuration message to the RIS, the configuration message indicating respective uplink reflection angles, respective downlink reflection angles, or both for a set of multiple elements of the RIS.

In some examples, the UE includes a first UE and the RIS includes a first RIS, and the communication component 1335 may be configured as or otherwise support a means for communicating with a second UE via a second RIS.

In some examples, the UE includes a first UE, the RIS includes a set of multiple elements, and the communicating includes communicating with the first UE via a first subset of elements of the set of multiple elements of the RIS. In some such examples, the communication component 1335 may be configured as or otherwise support a means for communicating with a second UE via a second subset of elements of the set of multiple elements of the RIS.

In some examples, the RIS reassignment component 1355 may be configured as or otherwise support a means for determining that the first UE leaves a wireless network including the base station. In some examples, the RIS reassignment component 1355 may be configured as or otherwise support a means for determining that a third UE accesses the wireless network including the base station. In some examples, the RIS reassignment component 1355 may be configured as or otherwise support a means for reassigning the first subset of elements of the set of multiple elements of the RIS to the third UE based on the third UE accessing the wireless network and the first UE leaving the wireless network.

In some examples, the RIS activation component 1345 may be configured as or otherwise support a means for activating the RIS based on the configuration of the RIS, where communicating with the UE via the RIS is based on the activating.

In some examples, the configuration of the RIS indicates a set of time resources, a set of frequency resources, or both assigned to the RIS. In some examples, the configuration of the RIS includes a location of the RIS, an uplink reflection angle of the RIS, a downlink reflection angle of the RIS, or a combination thereof.

In some examples, the RIS includes a first sub-RIS of a total RIS. In some examples, the location of the RIS includes a relative location of the first sub-RIS relative to a second sub-RIS of the total RIS, the uplink reflection angle of the RIS includes a relative uplink reflection angle of the first sub-RIS relative to an uplink reflection angle of the second sub-RIS of the total RIS, the downlink reflection angle of the RIS includes a relative downlink reflection angle of the first sub-RIS relative to a downlink reflection angle of the second sub-RIS of the total RIS, or a combination thereof.

In some examples, the message includes a DCI message, an RRC configuration message, a MAC CE, or a combination thereof.

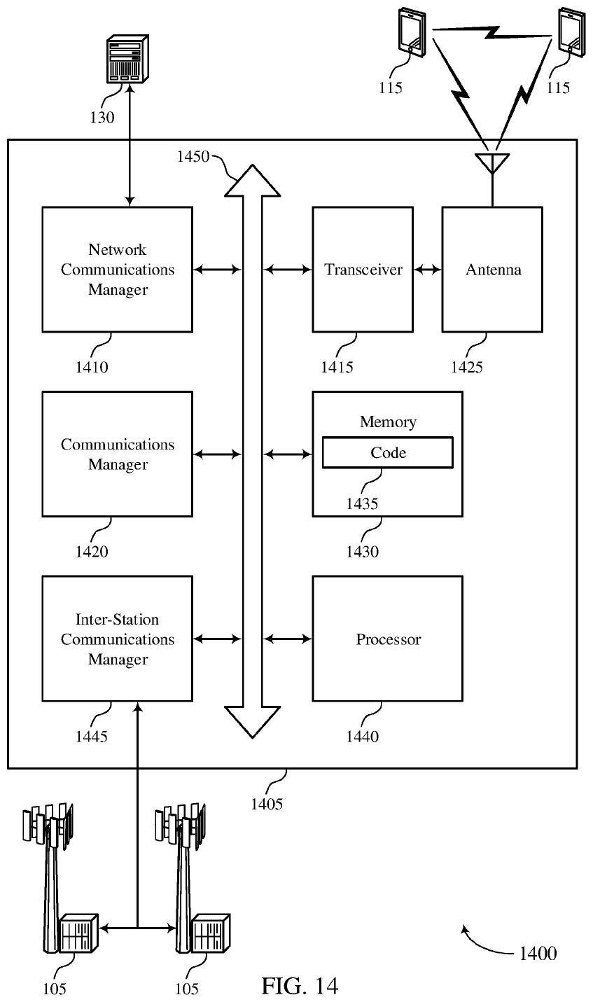

FIG. 14 shows a diagram of a system 1400 including a device 1405 that supports communicating RIS information to support RDMA in accordance with aspects of the present disclosure. The device 1405 may be an example of or include the components of a device 1105, a device 1205, or a base station 105 as described herein. The device 1405 may communicate wirelessly with one or more base stations 105, UEs 115, or a combination thereof. The device 1405 may include components for bi-directional voice and data communications including components for transmitting and receiving communications, such as a communications manager 1420, a network communications manager 1410, a transceiver 1415, an antenna 1425, a memory 1430, code 1435, a processor 1440, and an inter-station communications manager 1445. These components may be in electronic communication or otherwise coupled (e.g., operatively, communicatively, functionally, electronically, electrically) via one or more buses (e.g., a bus 1450).

The network communications manager 1410 may manage communications with a core network 130 (e.g., via one or more wired backhaul links). For example, the network communications manager 1410 may manage the transfer of data communications for client devices, such as one or more UEs 115.

In some cases, the device 1405 may include a single antenna 1425. However, in some other cases the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or a combination thereof or component thereof, as described herein.

The memory 1430 may include RAM and ROM. The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a BIOS which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or a combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting communicating RIS information to support RDMA). For example, the device 1405 or a component of the device 1405 may include a processor 1440 and memory 1430 coupled to the processor 1440, the processor 1440 and memory 1430 configured to perform various functions described herein.

The inter-station communications manager 1445 may manage communications with other base stations 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communications network technology to provide communication between base stations 105.

The communications manager 1420 may support wireless communications at a base station in accordance with examples as disclosed herein. For example, the communications manager 1420 may be configured as or otherwise support a means for determining a configuration of a RIS. The communications manager 1420 may be configured as or otherwise support a means for transmitting, to a UE, a message indicating the configuration of the RIS. The communications manager 1420 may be configured as or otherwise support a means for communicating with the UE via the RIS based on the configuration of the RIS.

By including or configuring the communications manager 1420 in accordance with examples as described herein, the device 1405 may support techniques for reduced processing, reduced power consumption, and more efficient utilization of communication resources. For example, the communications manager 1420 may, based on implementing the techniques described herein, transmit configuration information for a RIS such that the communications manager 1420, or one or more processing components of the communications manager 1420, can use the RIS to communicate with one or more UEs 115 with increased reliability. As such, the communications manager 1420 may request and transmit fewer retransmissions than communicating without the RIS, which may result in improved power savings and reduced channel overhead in the network.

In some examples, the communications manager 1420 may be configured to perform various operations (e.g., receiving, monitoring, transmitting) using or otherwise in cooperation with the transceiver 1415, the one or more antennas 1425, or a combination thereof. Although the communications manager 1420 is illustrated as a separate component, in some examples, one or more functions described with reference to the communications manager 1420 may be supported by or performed by the processor 1440, the memory 1430, the code 1435, or a combination thereof. For example, the code 1435 may include instructions executable by the processor 1440 to cause the device 1405 to perform various aspects of communicating RIS information to support RDMA as described herein, or the processor 1440 and the memory 1430 may be otherwise configured to perform or support such operations.

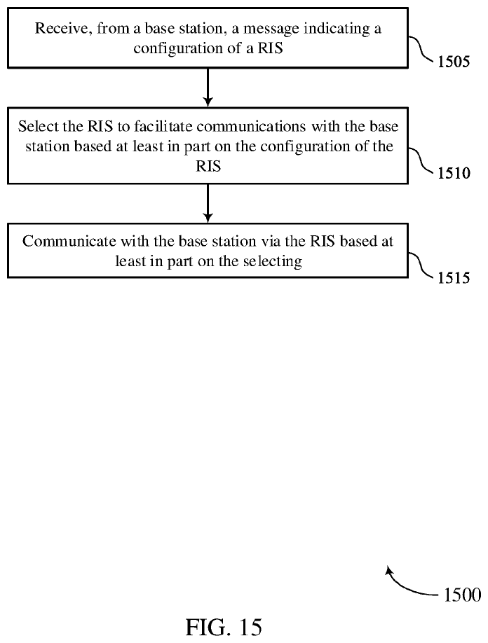

FIG. 15 shows a flowchart illustrating a method 1500 that supports communicating RIS information to support RDMA in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1505, the method may include receiving, from a base station, a message indicating a configuration of a RIS. The operations of 1505 may be performed in accordance with examples as disclosed herein. In some examples, aspects of the operations of 1505 may be performed by a RIS configuration component 925 as described with reference to FIG. 9.

At 1510, the method may include selecting the RIS to facilitate communications with the base station based on the configuration of the RIS. The operations of 1510 may be performed in accordance with examples as disclosed herein. In some examples, aspects of the operations of 1510 may be performed by a RIS selection component 930 as described with reference to FIG. 9.

At 1515, the method may include communicating with the base station via the RIS based on the selecting. The operations of 1515 may be performed in accordance with examples as disclosed herein. In some examples, aspects of the operations of 1515 may be performed by a communication component 935 as described with reference to FIG. 9.

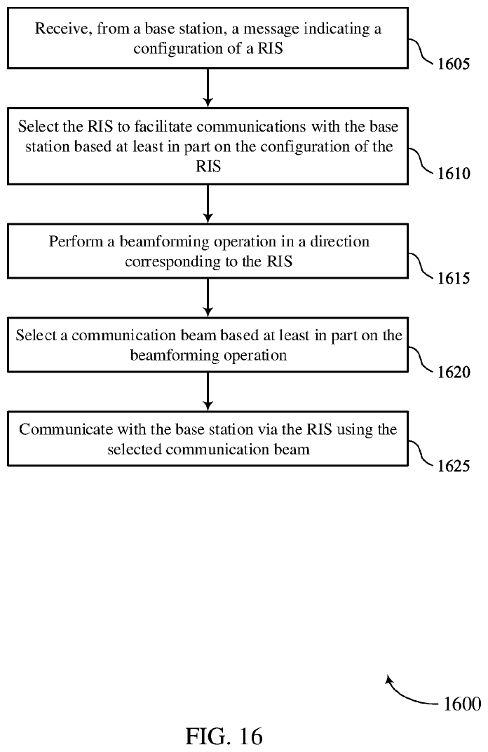

FIG. 16 shows a flowchart illustrating a method 1600 that supports communicating RIS information to support RDMA in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1605, the method may include receiving, from a base station, a message indicating a configuration of a RIS. The operations of 1605 may be performed in accordance with examples as disclosed herein. In some examples, aspects of the operations of 1605 may be performed by a RIS configuration component 925 as described with reference to FIG. 9.

At 1610, the method may include selecting the RIS to facilitate communications with the base station based on the configuration of the RIS. The operations of 1610 may be performed in accordance with examples as disclosed herein. In some examples, aspects of the operations of 1610 may be performed by a RIS selection component 930 as described with reference to FIG. 9.

At 1615, the method may include performing a beamforming operation in a direction corresponding to the RIS. The operations of 1615 may be performed in accordance with examples as disclosed herein. In some examples, aspects of the operations of 1615 may be performed by a beamforming component 940 as described with reference to FIG. 9.

At 1620, the method may include selecting a communication beam based on the beamforming operation. The operations of 1620 may be performed in accordance with examples as disclosed herein. In some examples, aspects of the operations of 1620 may be performed by a beamforming component 940 as described with reference to FIG. 9.

At 1625, the method may include communicating with the base station via the RIS using the selected communication beam. The operations of 1625 may be performed in accordance with examples as disclosed herein. In some examples, aspects of the operations of 1625 may be performed by a communication component 935 as described with reference to FIG. 9.

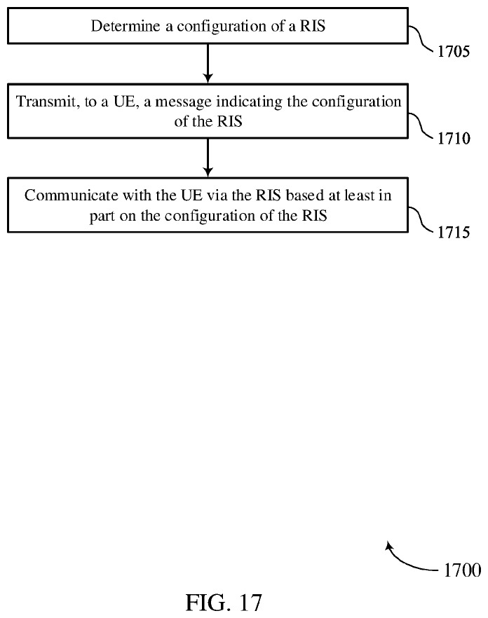

FIG. 17 shows a flowchart illustrating a method 1700 that supports communicating RIS information to support RDMA in accordance with aspects of the present disclosure. The operations of the method 1700 may be implemented by a base station or its components as described herein. For example, the operations of the method 1700 may be performed by a base station 105 as described with reference to FIGS. 1 through 6 and 11 through 14. In some examples, a base station may execute a set of instructions to control the functional elements of the base station to perform the described functions. Additionally or alternatively, the base station may perform aspects of the described functions using special-purpose hardware.

At 1705, the method may include determining a configuration of a RIS. The operations of 1705 may be performed in accordance with examples as disclosed herein. In some examples, aspects of the operations of 1705 may be performed by a RIS configuration component 1325 as described with reference to FIG. 13.

At 1710, the method may include transmitting, to a UE, a message indicating the configuration of the RIS. The operations of 1710 may be performed in accordance with examples as disclosed herein. In some examples, aspects of the operations of 1710 may be performed by a RIS configuration messaging component 1330 as described with reference to FIG. 13.

At 1715, the method may include communicating with the UE via the RIS based on the configuration of the RIS. The operations of 1715 may be performed in accordance with examples as disclosed herein. In some examples, aspects of the operations of 1715 may be performed by a communication component 1335 as described with reference to FIG. 13.

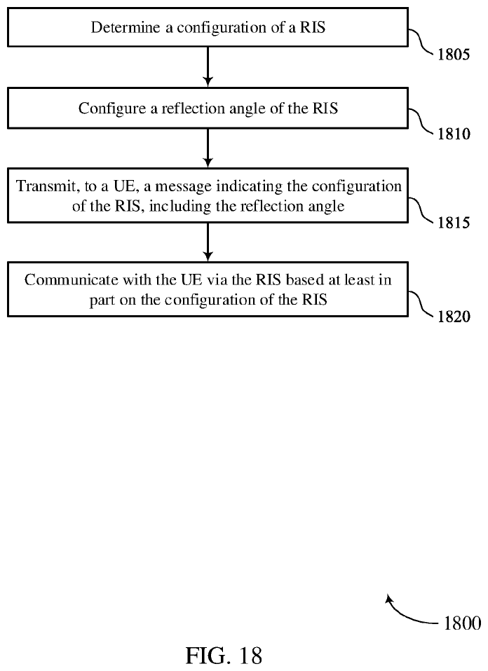

FIG. 18 shows a flowchart illustrating a method 1800 that supports communicating RIS information to support RDMA in accordance with aspects of the present disclosure. The operations of the method 1800 may be implemented by a base station or its components as described herein. For example, the operations of the method 1800 may be performed by a base station 105 as described with reference to FIGS. 1 through 6 and 11 through 14. In some examples, a base station may execute a set of instructions to control the functional elements of the base station to perform the described functions. Additionally or alternatively, the base station may perform aspects of the described functions using special-purpose hardware.

At 1805, the method may include determining a configuration of a RIS. The operations of 1805 may be performed in accordance with examples as disclosed herein. In some examples, aspects of the operations of 1805 may be performed by a RIS configuration component 1325 as described with reference to FIG. 13.

At 1810, the method may include configuring an uplink reflection angle of the RIS, configuring a downlink reflection angle of the RIS, or both. The operations of 1810 may be performed in accordance with examples as disclosed herein. In some examples, aspects of the operations of 1810 may be performed by a RIS configuration component 1325 as described with reference to FIG. 13.

At 1815, the method may include transmitting, to a UE, a message indicating the configuration of the RIS, where the configuration of the RIS includes the configured uplink reflection angle of the RIS, the configured downlink reflection angle of the RIS, or both. The operations of 1815 may be performed in accordance with examples as disclosed herein. In some examples, aspects of the operations of 1815 may be performed by a RIS configuration messaging component 1330 as described with reference to FIG. 13.

At 1820, the method may include communicating with the UE via the RIS based on the configuration of the RIS. The operations of 1820 may be performed in accordance with examples as disclosed herein. In some examples, aspects of the operations of 1820 may be performed by a communication component 1335 as described with reference to FIG. 13.

The following provides an overview of aspects of the present disclosure:

Aspect 1: A method for wireless communications at a UE, comprising: receiving, from a base station, a message indicating a configuration of a RIS; selecting the RIS to facilitate communications with the base station based at least in part on the configuration of the RIS; and communicating with the base station via the RIS based at least in part on the selecting.

Aspect 2: The method of aspect 1, wherein communicating with the base station via the RIS comprises: performing a beamforming operation in a direction corresponding to the RIS; selecting a communication beam based at least in part on the beamforming operation; and communicating with the base station via the RIS using the selected communication beam.

Aspect 3: The method of any of aspects 1 through 2, wherein the RIS comprises a plurality of elements, the method further comprising: determining a subset of elements of the plurality of elements of the RIS based at least in part on the configuration of the RIS, wherein the communicating comprises communicating with the base station via the subset of elements.

Aspect 4: The method of any of aspects 1 through 3, wherein the RIS comprises a plurality of elements, the method further comprising: accessing a wireless network comprising the base station, wherein the message is received based at least in part on accessing the wireless network and the message assigns the UE a subset of elements of the plurality of elements of the RIS for communication.

Aspect 5: The method of any of aspects 1 through 4, wherein the message indicates a plurality of configurations for a plurality of RISs in a wireless network.

Aspect 6: The method of aspect 5, wherein selecting the RIS comprises: selecting the RIS of the plurality of RISs for communication based at least in part on a position of the UE, a position of the base station, a position of the RIS indicated by the configuration of the RIS, an uplink reflection angle of the RIS indicated by the configuration of the RIS, a downlink reflection angle of the RIS indicated by the configuration of the RIS, a reference signal measurement associated with the RIS, or a combination thereof.

Aspect 7: The method of aspect 6, further comprising: transmitting, to the base station, a feedback message indicating the selected RIS.

Aspect 8: The method of aspect 7, wherein the feedback message comprises a channel state information feedback message.

Aspect 9: The method of any of aspects 1 through 8, wherein the message assigns the RIS to the UE for a set of time resources, a set of frequency resources, or both; and the communicating comprises communicating with the base station via the assigned RIS in the set of time resources, the set of frequency resources, or both.

Aspect 10: The method of any of aspects 1 through 9, wherein the configuration of the RIS indicates a set of time resources, a set of frequency resources, or both assigned to the RIS.

Aspect 11: The method of any of aspects 1 through 10, wherein the configuration of the RIS comprises a location of the RIS, an uplink reflection angle of the RIS, a downlink reflection angle of the RIS, or a combination thereof.

Aspect 12: The method of aspect 11, wherein the RIS comprises a first sub-RIS of a total RIS; and the location of the RIS comprises a relative location of the first sub-RIS relative to a second sub-RIS of the total RIS, the uplink reflection angle of the RIS comprises a relative uplink reflection angle of the first sub-RIS relative to an uplink reflection angle of the second sub-RIS of the total RIS, the downlink reflection angle of the RIS comprises a relative downlink reflection angle of the first sub-RIS relative to a downlink reflection angle of the second sub-RIS of the total RIS, or a combination thereof.

Aspect 13: The method of any of aspects 1 through 12, wherein the message comprises a DCI message, an RRC configuration message, a MAC CE, or a combination thereof.

Aspect 14: A method for wireless communications at a base station, comprising: determining a configuration of a RIS; transmitting, to a UE, a message indicating the configuration of the RIS; and communicating with the UE via the RIS based at least in part on the configuration of the RIS.

Aspect 15: The method of aspect 14, wherein communicating with the UE via the RIS comprises: performing a beamforming operation in a direction corresponding to the RIS; selecting a communication beam based at least in part on the beamforming operation; and communicating with the UE via the RIS using the selected communication beam.

Aspect 16: The method of any of aspects 14 through 15, wherein the message indicates a plurality of configurations for a plurality of RISs in a wireless network comprising the base station.

Aspect 17: The method of aspect 16, further comprising: receiving, from the UE, a feedback message indicating that the UE selected the RIS for communication, wherein communicating with the UE via the RIS is based at least in part on the feedback message.

Aspect 18: The method of aspect 17, wherein the feedback message comprises a CSI feedback message.

Aspect 19: The method of any of aspects 14 through 18, wherein the message assigns the RIS to the UE for a set of time resources, a set of frequency resources, or both; and the communicating comprises communicating with the UE via the assigned RIS in the set of time resources, the set of frequency resources, or both.

Aspect 20: The method of any of aspects 14 through 19, wherein determining the configuration of the RIS comprises: configuring an uplink reflection angle of the RIS, a downlink reflection angle of the RIS, or both, wherein the configuration of the RIS comprises the uplink reflection angle of the RIS, the downlink reflection angle of the RIS, or both.

Aspect 21: The method of aspect 20, wherein configuring the uplink reflection angle of the RIS, the downlink reflection angle of the RIS, or both comprises: transmitting a configuration message to the RIS, the configuration message indicating respective uplink reflection angles, respective downlink reflection angles, or both for a plurality of elements of the RIS.

Aspect 22: The method of any of aspects 14 through 21, wherein the UE comprises a first UE and the RIS comprises a first RIS, the method further comprising: communicating with a second UE via a second RIS.

Aspect 23: The method of any of aspects 14 through 22, wherein the UE comprises a first UE; the RIS comprises a plurality of elements; the communicating comprises communicating with the first UE via a first subset of elements of the plurality of elements of the RIS, the method further comprising: communicating with a second UE via a second subset of elements of the plurality of elements of the RIS.

Aspect 24: The method of aspect 23, further comprising: determining that the first UE leaves a wireless network comprising the base station; determining that a third UE accesses the wireless network comprising the base station; and reassigning the first subset of elements of the plurality of elements of the RIS to the third UE based at least in part on the third UE accessing the wireless network and the first UE leaving the wireless network.

Aspect 25: The method of any of aspects 14 through 24, further comprising: activating the RIS based at least in part on the configuration of the RIS, wherein communicating with the UE via the RIS is based at least in part on the activating.

Aspect 26: The method of any of aspects 14 through 25, wherein the configuration of the RIS indicates a set of time resources, a set of frequency resources, or both assigned to the RIS.

Aspect 27: The method of any of aspects 14 through 26, wherein the configuration of the RIS comprises a location of the RIS, an uplink reflection angle of the RIS, a downlink reflection angle of the RIS, or a combination thereof.

Aspect 28: The method of aspect 27, wherein the RIS comprises a first sub-RIS of a total RIS; and the location of the RIS comprises a relative location of the first sub-RIS relative to a second sub-RIS of the total RIS, the uplink reflection angle of the RIS comprises a relative uplink reflection angle of the first sub-RIS relative to an uplink reflection angle of the second sub-RIS of the total RIS, the downlink reflection angle of the RIS comprises a relative downlink reflection angle of the first sub-RIS relative to a downlink reflection angle of the second sub-RIS of the total RIS, or a combination thereof.

Aspect 29: The method of any of aspects 14 through 28, wherein the message comprises a DCI message, an RRC configuration message, a MAC CE, or a combination thereof.

Aspect 30: An apparatus for wireless communications at a UE, comprising a processor; memory in electronic communication with the processor; and instructions stored in the memory, wherein the instructions are executable by the processor to perform a method of any of aspects 1 through 13.

Aspect 31: An apparatus for wireless communications at a UE, comprising at least one means for performing a method of any of aspects 1 through 13.

Aspect 32: A non-transitory computer-readable medium storing code for wireless communications at a UE, the code comprising instructions executable by a processor to perform a method of any of aspects 1 through 13.

Aspect 33: An apparatus for wireless communications at a base station, comprising a processor; memory in electronic communication with the processor; and instructions stored in the memory, wherein the instructions are executable by the processor to perform a method of any of aspects 14 through 29.

Aspect 34: An apparatus for wireless communications at a base station, comprising at least one means for performing a method of any of aspects 14 through 29.

Aspect 35: A non-transitory computer-readable medium storing code for wireless communications at a base station, the code comprising instructions executable by a processor to perform a method of any of aspects 14 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or a combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or a combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or a combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a base station, a message indicating a configuration of a reconfigurable intelligent surface (RIS);
selecting the RIS to facilitate communications with the base station based at least in part on the configuration of the RIS; and
communicating with the base station via the RIS based at least in part on the selecting.

2. The method of claim 1, wherein communicating with the base station via the RIS comprises:
performing a beamforming operation in a direction corresponding to the RIS;
selecting a communication beam based at least in part on the beamforming operation; and
communicating with the base station via the RIS using the selected communication beam.

3. The method of claim 1, wherein the RIS comprises a plurality of elements, the method further comprising:
determining a subset of elements of the plurality of elements of the RIS based at least in part on the configuration of the RIS, wherein the communicating comprises communicating with the base station via the subset of elements.

4. The method of claim 1, wherein the RIS comprises a plurality of elements, the method further comprising:
accessing a wireless network comprising the base station, wherein the message is received based at least in part on accessing the wireless network and the message assigns the UE a subset of elements of the plurality of elements of the RIS for communication.

5. The method of claim 1, wherein the message indicates a plurality of configurations for a plurality of RISs in a wireless network.

6. The method of claim 5, wherein selecting the RIS comprises:
selecting the RIS of the plurality of RISs for communication based at least in part on a position of the UE, a position of the base station, a position of the RIS indicated by the configuration of the RIS, an uplink reflection angle of the RIS indicated by the configuration of the RIS, a downlink reflection angle of the RIS indicated by the configuration of the RIS, a reference signal measurement associated with the RIS, or a combination thereof.

7. The method of claim 6, further comprising:
transmitting, to the base station, a feedback message indicating the selected RIS.

8. The method of claim 7, wherein the feedback message comprises a channel state information feedback message.

9. The method of claim 1, wherein:
the message assigns the RIS to the UE for a set of time resources, a set of frequency resources, or both; and
the communicating comprises communicating with the base station via the assigned RIS in the set of time resources, the set of frequency resources, or both.

10. The method of claim 1, wherein the configuration of the RIS indicates a set of time resources, a set of frequency resources, or both assigned to the RIS.

11. The method of claim 1, wherein the configuration of the RIS comprises a location of the RIS, an uplink reflection angle of the RIS, a downlink reflection angle of the RIS, or a combination thereof.

12. The method of claim 11, wherein:
the RIS comprises a first sub-RIS of a total RIS; and
the location of the RIS comprises a relative location of the first sub-RIS relative to a second sub-RIS of the total RIS, the uplink reflection angle of the RIS comprises a relative uplink reflection angle of the first sub-RIS relative to an uplink reflection angle of the second sub-RIS of the total RIS, the downlink reflection angle of the RIS comprises a relative downlink reflection angle of the first sub-RIS relative to a downlink reflection angle of the second sub-RIS of the total RIS, or a combination thereof.

13. The method of claim 1, wherein the message comprises a downlink control information message, a radio resource control configuration message, a medium access control control element, or a combination thereof.

14. A method for wireless communications at a base station, comprising:
determining a configuration of a reconfigurable intelligent surface (RIS);
transmitting, to a user equipment (UE), a message indicating the configuration of the RIS; and
communicating with the UE via the RIS based at least in part on the configuration of the RIS.

15. The method of claim 14, wherein communicating with the UE via the RIS comprises:
performing a beamforming operation in a direction corresponding to the RIS;
selecting a communication beam based at least in part on the beamforming operation; and
communicating with the UE via the RIS using the selected communication beam.

16. The method of claim 14, wherein the message indicates a plurality of configurations for a plurality of RISs in a wireless network comprising the base station.

17. The method of claim 16, further comprising:
receiving, from the UE, a feedback message indicating that the UE selected the RIS for communication, wherein communicating with the UE via the RIS is based at least in part on the feedback message.

18. The method of claim 17, wherein the feedback message comprises a channel state information feedback message.

19. The method of claim 14, wherein:
the message assigns the RIS to the UE for a set of time resources, a set of frequency resources, or both; and
the communicating comprises communicating with the UE via the assigned RIS in the set of time resources, the set of frequency resources, or both.

20. The method of claim 14, wherein determining the configuration of the RIS comprises:
configuring an uplink reflection angle of the RIS, a downlink reflection angle of the RIS, or both, wherein the configuration of the RIS comprises the uplink reflection angle of the RIS, the downlink reflection angle of the RIS, or both.

21. The method of claim 20, wherein configuring the uplink reflection angle of the RIS, the downlink reflection angle of the RIS, or both comprises:
transmitting a configuration message to the RIS, the configuration message indicating respective uplink reflection angles, respective downlink reflection angles, or both for a plurality of elements of the RIS.

22. The method of claim 14, wherein the UE comprises a first UE and the RIS comprises a first RIS, the method further comprising:
communicating with a second UE via a second RIS.

23. The method of claim 14, wherein:
the UE comprises a first UE;
the RIS comprises a plurality of elements; and
the communicating comprises communicating with the first UE via a first subset of elements of the plurality of elements of the RIS, the method further comprising:
communicating with a second UE via a second subset of elements of the plurality of elements of the RIS.

24. The method of claim 23, further comprising:
determining that the first UE leaves a wireless network comprising the base station;
determining that a third UE accesses the wireless network comprising the base station; and
reassigning the first subset of elements of the plurality of elements of the RIS to the third UE based at least in part on the third UE accessing the wireless network and the first UE leaving the wireless network.

25. The method of claim 14, further comprising:
activating the RIS based at least in part on the configuration of the RIS, wherein communicating with the UE via the RIS is based at least in part on the activating.

26. An apparatus for wireless communications at a user equipment (UE), comprising:
a processor;
memory in electronic communication with the processor; and
instructions stored in the memory, wherein the instructions are executable by the processor to:
receive, from a base station, a message indicating a configuration of a reconfigurable intelligent surface (RIS);
select the RIS to facilitate communications with the base station based at least in part on the configuration of the RIS; and
communicate with the base station via the RIS based at least in part on the selecting.

27. The apparatus of claim 26, wherein the instructions executable by the processor to communicate with the base station via the RIS comprise instructions executable by the processor to:
perform a beamforming operation in a direction corresponding to the RIS;
select a communication beam based at least in part on the beamforming operation; and
communicate with the base station via the RIS using the selected communication beam.

28. The apparatus of claim 26, wherein the RIS comprises a plurality of elements, and the instructions are further executable by the processor to:
determine a subset of elements of the plurality of elements of the RIS based at least in part on the configuration of the RIS, wherein the communicating comprises communicating with the base station via the subset of elements.

29. The apparatus of claim 26, wherein the RIS comprises a plurality of elements, and the instructions are further executable by the processor to:
access a wireless network comprising the base station, wherein the message is received based at least in part on accessing the wireless network and the message assigns the UE a subset of elements of the plurality of elements of the RIS for communication.

30. An apparatus for wireless communications at a base station, comprising:
a processor;
memory in electronic communication with the processor; and
instructions stored in the memory, wherein the instructions are executable by the processor to:
determine a configuration of a reconfigurable intelligent surface (RIS);
transmit, to a user equipment (UE), a message indicating the configuration of the RIS; and
communicate with the UE via the RIS based at least in part on the configuration of the RIS.
